(19) United States
(12) Patent Application Publication
(10) Pub. No.: US 2025/0004393 A1
(43) Pub. Date: Jan. 2, 2025

(54) IMAGE FORMING APPARATUS AND CARTRIDGE

(71) Applicant: CANON KABUSHIKI KAISHA, Tokyo (JP)

(72) Inventors: TOSHIYA GOTO, Kanagawa (JP); MAKOTO HAYASHIDA, Shizuoka (JP); RYUTA MURAKAMI, Shizuoka (JP)

(21) Appl. No.: 18/758,122

(22) Filed: Jun. 28, 2024

(30) Foreign Application Priority Data
Jun. 29, 2023 (JP) 2023-107185

(51) Int. Cl. G03G 15/08

(52) U.S. Cl. CPC G03G 15/0862; G03G 15/0875

(57) ABSTRACT

An image forming apparatus includes a sensing portion that has a light-emitting portion and a light-receiving portion that receives light from the light-emitting portion, the light from inside of a toner accommodating portion to outside of the toner accommodating portion via a light-transmitting portion. The light-transmitting portion has a first lightguide portion that guides the light to the inside of the toner accommodating portion, and a second lightguide portion that guides the light to the light-receiving portion. The image forming apparatus further includes a cover member that covers the first lightguide portion and the second lightguide portion. A part of the second lightguide portion that is closest to a passage region of laser light is at a position closer to the passage region than any of parts of the first lightguide portion, and a cover member is configured so as not to cover the part that is closest.

### BACKGROUND OF THE INVENTION

### Field of the Invention

The present invention relates to an image forming apparatus that uses an electrophotographic image forming process, and a cartridge that is detachable from and attachable to an apparatus main body of the image forming apparatus.

### Description of the Related Art

In order to continue to use an image forming apparatus that uses for prolonged periods an electrophotographic image forming process, there is a need to comprehend a consumed amount of toner (developer) and replenish the toner as appropriate, and heretofore, various types of methods have been proposed as means for sensing a remaining amount of toner accommodated in a toner accommodating portion. Particularly, in cartridge-type apparatuses, in which image forming means is made into a cartridge, such as a developing cartridge, a process cartridge or the like, which are detachable from and attachable to an apparatus main body, remaining toner amount sensing is used as one means for knowing cartridge replacement timing (Japanese Patent Application Publication Nos. 2003-167490 and 2009-288304).

With regard to a remaining toner amount sensing technique, a technique is known in which part of a frame body that has a toner accommodating portion is made of a light-transmitting member, and the amount of toner in the toner accommodating portion is sensed on the basis of change in the level of sensed light that has passed through inside of the toner accommodating portion via the light-transmitting member. For example, the remaining amount of toner can be sensed or predicted on the basis of a degree (e.g., time) of sensed light being blocked by toner in the toner accommodating portion changing in accordance with the remaining toner amount.

Japanese Patent Application Publication No. 2003-167490 proposes a configuration of remaining toner amount sensing means in a cartridge-type image forming apparatus. In the configuration according to Japanese Patent Application Publication No. 2003-167490, a light-emitting portion such as a light-emitting diode (LED) or the like, and a light-receiving portion such as a phototransistor or the like, are provided in the apparatus main body, and a light guide that, as a light-transmitting member, guides sensing light into the toner accommodating portion and guides sensing light that has passed through the toner accommodating portion to the light-receiving portion is assembled into a cartridge frame body.

In Japanese Patent Application Publication No. 2009-288304, a configuration is proposed in which a periphery of a light-transmitting member is covered by a cover member that does not transmit light, in order to suppress malfunctioning of the apparatus from occurring due to reflected light of sensing light being sensed by other light-receiving elements provided to the apparatus main body.

### SUMMARY OF THE INVENTION

Providing a cover member as means to circumvent erroneous sensing by other light-receiving elements requires space to dispose the cover member. Securing this disposing space gives rise to a concern that the size of the cartridge will increase, or a concern that increasing volume of the toner accommodating portion in a small-sized cartridge will be impeded as a result of reducing the accommodating amount of the toner accommodating portion in order to circumvent increase in size.

It is an object of the present invention to provide technology that has little effect on apparatus layout, and that enables stable remaining toner amount sensing.

In order to achieve the above object, an image forming apparatus according to the present invention includes:
a photosensitive drum;
an exposing portion that exposes the photosensitive drum;
a developing portion that includes
   a frame body that has a toner accommodating portion,
   a developing roller that develops an electrostatic image, formed on the photosensitive drum by laser light from the exposing portion, by toner accommodated in the toner accommodating portion, and
   a light-transmitting portion attached to the frame body; and
a sensing portion that includes
   a light-emitting portion, and
   a light-receiving portion that receives light that is emitted from the light-emitting portion, and that passes through inside of the toner accommodating portion via the light-transmitting portion and exits to outside of the toner accommodating portion, the sensing portion emitting a sensing signal in accordance with a level of light received at the light-receiving portion,
wherein the light-transmitting portion includes
   a first lightguide portion that guides the light emitted from the light-emitting portion to the inside of the toner accommodating portion, and
   a second lightguide portion that guides the light that has passed through the inside of the toner accommodating portion to the light-receiving portion,
wherein the image forming apparatus has a cover member that covers the first lightguide portion and the second lightguide portion,
wherein a part of the second lightguide portion that is closest to a passage region where the laser light passes is at a position closer to the passage region than any of parts of the first lightguide portion, and
wherein the cover member is configured so as not to cover the part that is closest.

Also, in order to achieve the above object, a cartridge that is detachable from and attachable to an apparatus main body of the image forming apparatus according to the present invention includes:
a developing roller;
a frame body that has a toner accommodating portion;
a first lightguide portion that is attached to the frame body and that guides light for sensing an amount of toner accommodated in the toner accommodating portion, from outside of the toner accommodating portion to inside of the toner accommodating portion;
a second lightguide portion that is attached to the frame body and that guides the light that has passed through the inside of the toner accommodating portion to the outside of the toner accommodating portion; and
a cover member covering the first lightguide portion and the second lightguide portion,
wherein a part of the second lightguide portion that is closest to a passage region, where laser light for exposing a photosensitive drum of an exposing portion provided to the apparatus main body passes, is at a position closer to the passage region than any of parts of the first lightguide portion, and
wherein the cover member is configured so as not to cover the part that is closest.

According to the present invention, stable remaining toner amount sensing with little effect on apparatus layout is enabled.

Further features of the present invention will become apparent from the following description of exemplary embodiments with reference to the attached drawings.

### BRIEF DESCRIPTION OF THE DRAWINGS

FIGS. 1A and 1B are a perspective view and a cross-sectional view of principal portions extracted from a process cartridge and a printer main body;

FIG. 2 is a cross-sectional view schematically illustrating a laser printer;

FIG. 3 is a frontal view schematically illustrating a process cartridge;

FIG. 4 is a cross-sectional view schematically illustrating the process cartridge;

FIG. 5 is a cross-sectional view illustrating a second waste toner transport path of the process cartridge;

FIG. 6 is a cross-sectional view illustrating a replenishing port of the process cartridge;

FIGS. 7A and 7B are disassembled perspective views of the process cartridge;

FIGS. 8A and 8B are schematic side views illustrating abutting of a developing unit as to a photosensitive drum in the process cartridge, and spacing therebetween;

FIG. 9 is a frontal view schematically illustrating a toner cartridge;

FIG. 10 is a cross-sectional view illustrating a toner supply unit of the toner cartridge;

FIG. 11 is a cross-sectional view illustrating a waste toner recovery unit of the toner cartridge;

FIGS. 12A and 12B are disassembled perspective views of the toner cartridge;

FIGS. 13A and 13B are schematic perspective views illustrating attaching of the process cartridge and the toner cartridge to the printer main body;

FIGS. 14A to 14C are schematic side views illustrating attaching of the process cartridge and the toner cartridge to the printer main body;

FIGS. 15A and 15B are a top view and a cross-sectional view of principal portions extracted from the process cartridge;

FIGS. 16A and 16B are a disassembled perspective view and an enlarged view of principal portions extracted from the developing unit;

FIGS. 17A and 17B are a top view and a cross-sectional view of principal portions extracted from the process cartridge and the printer main body;

FIGS. 18A and 18B are schematic diagrams of attaching, illustrating principal portions extracted from the process cartridge and the printer main body;

FIGS. 19A and 19B are a perspective view and a cross-sectional view of principal portions extracted from the developing unit; and

FIG. 20 is a circuit diagram illustrating a basic configuration of a remaining toner amount sensor.

### DESCRIPTION OF THE EMBODIMENTS

An embodiment for carrying out the invention will be exemplarily described below in detail by way of Embodiments, with reference to the Figures. Note that the dimensions, materials, shapes, relative placements thereof, and so forth, of the components described in the embodiment are to be changed as appropriate in accordance with a configuration of an apparatus to which the invention is to be applied, and various conditions. That is to say, the embodiment is not intended to limit the scope of this invention thereto. Also, not all features described in the Embodiments are necessarily indispensable for solving means of the invention.

A case of applying the present invention to an electrophotographic image forming apparatus will be exemplarily described below. An electrophotographic image forming apparatus forms images on a recording medium by using an electrophotographic image forming system. Examples of electrophotographic image forming apparatuses include an electrophotography photocopier, an electrophotographic printer (LED printer, laser beam printer, or the like), a facsimile apparatus, a word processor, and so forth.

### Embodiment 1

### Image Forming Apparatus

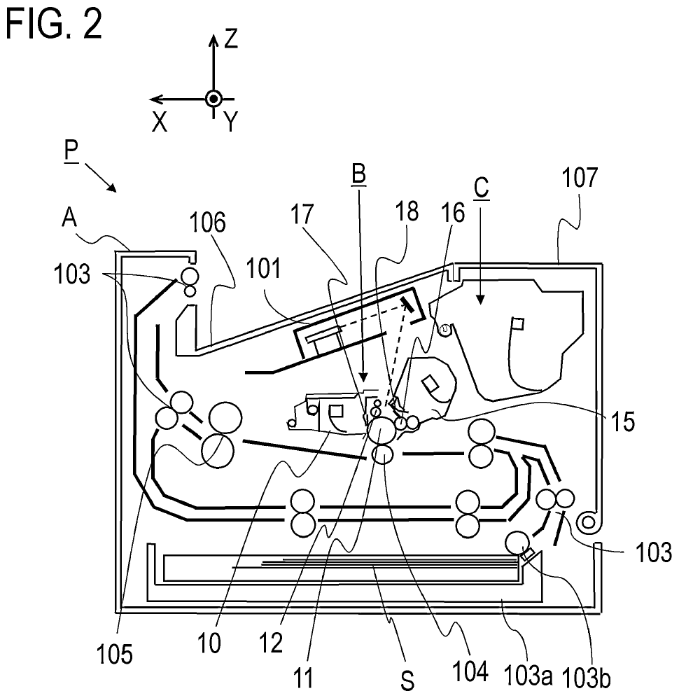

A configuration of an image forming apparatus P according to Embodiment 1 of the preset invention will be described with reference to FIG. 2. FIG. 2 is a schematic cross-sectional view illustrating a schematic configuration of the image forming apparatus P, which is a laser printer that forms (records) images on a sheet S serving as a recording material. As illustrated in FIG. 2, the image forming apparatus P is made up of a printer main body A, a process cartridge B, and a toner cartridge C.

Installed in the printer main body A are a sheet feeding unit 103, a transfer roller 104, a fixing unit 105, and a laser scanner 101. Also, the process cartridge B and the toner cartridge C are disposed so as to be detachable from and attachable to the printer main body A serving as the main body of the image forming apparatus P. The process cartridge B and the toner cartridge C are each configured to be detachable from and attachable to the printer main body A. Details of a configuration for attaching and detaching the process cartridge B and the toner cartridge C to and from the printer main body A will be described later.

The process cartridge B includes a photosensitive drum 11 serving as an image bearing member, and a charging roller 12 serving as a charging member. When the process cartridge B is attached to the printer main body A, the photosensitive drum 11 comes into contact with the transfer roller 104 serving as a transfer member, and forms, together with the transfer roller 104, a nip portion.

### Image Forming Operations

Next, image forming operations of the image forming apparatus P will be described. The photosensitive drum 11, which is rotationally driven by a driving source that is omitted from illustration, is uniformly charged to a predetermined potential by the charging roller 12. The surface of the photosensitive drum 11 following charging is subjected to exposure by laser light emitted from the laser scanner 101 serving as a laser unit (exposing portion) based on image information, whereby an electrostatic latent image (electrostatic image) is formed by the charge being removed from the exposed portions. Toner serving as a developer is then supplied from a developing roller 16 serving as a developer bearing member, to the electrostatic latent image on the photosensitive drum 11, thereby visualizing the electrostatic latent image as a toner image (developer image).

Also, in parallel with such toner image forming operations, a sheet S is transported by the sheet feeding unit 103. The sheet feeding unit 103 includes a sheet feeding tray 103a and a sheet feeding roller 103b, with sheets S being fed from the sheet feeding tray 103a by the sheet feeding roller 103b rotating. The sheet S is transported to the nip portion between the photosensitive drum 11 and the transfer roller 104 in accordance with the timing of the toner image being formed on the photosensitive drum 11. At the time of the sheet S passing through the nip portion, the toner image formed on the photosensitive drum 11 is transferred onto the sheet S as an unfixed image, by applying bias to the transfer roller 104. The sheet S on which the unfixed image is transferred is transported to the fixing unit 105. At the time of the sheet S passing through the fixing unit 105, the unfixed image is heated and pressurized, and thereby fixed onto the surface of the sheet S. Thereafter, the sheet S is transported by the sheet feeding unit 103, discharged to and stacked on a discharge tray 106, and the series of image forming operations is completed.

### Process Cartridge B

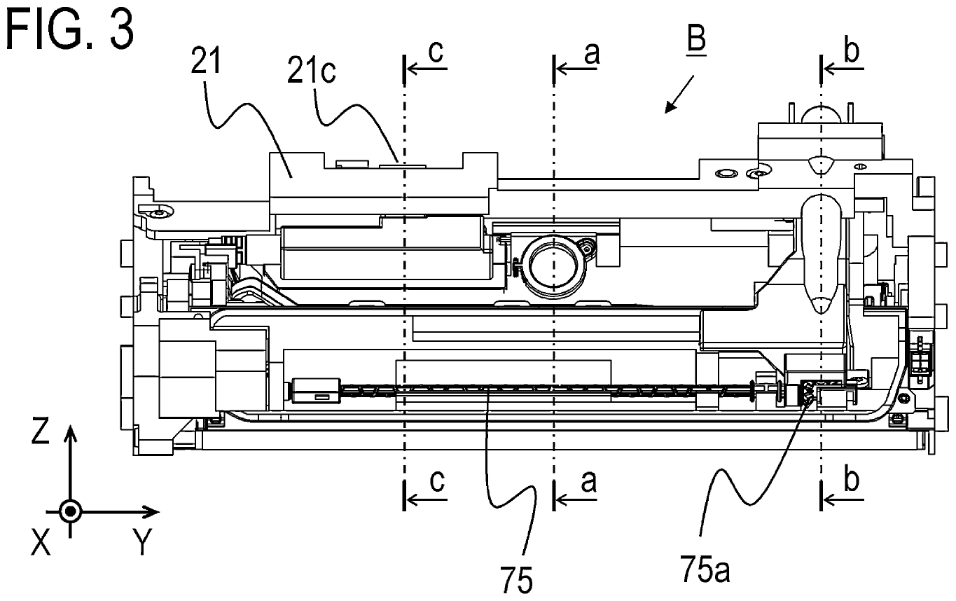

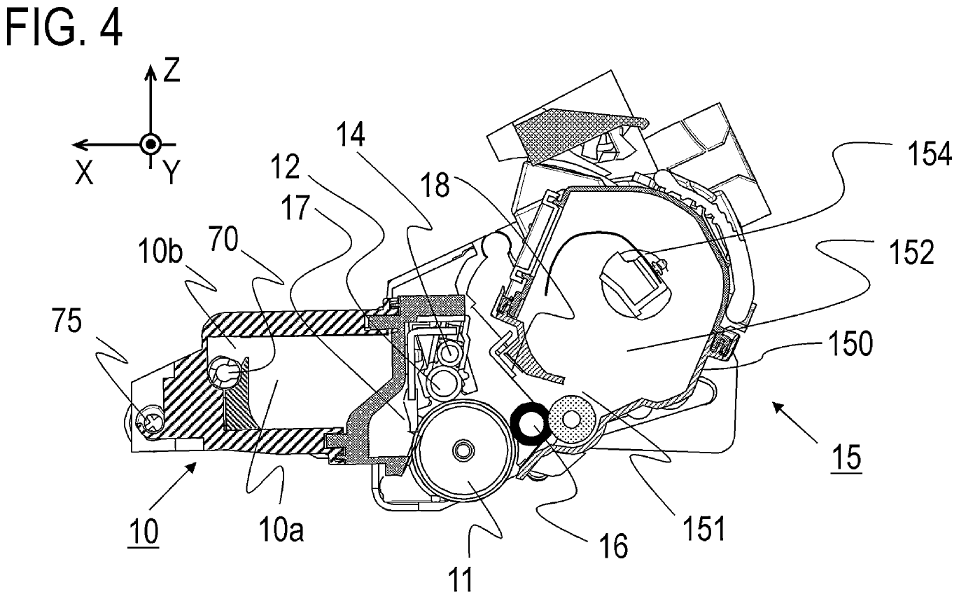

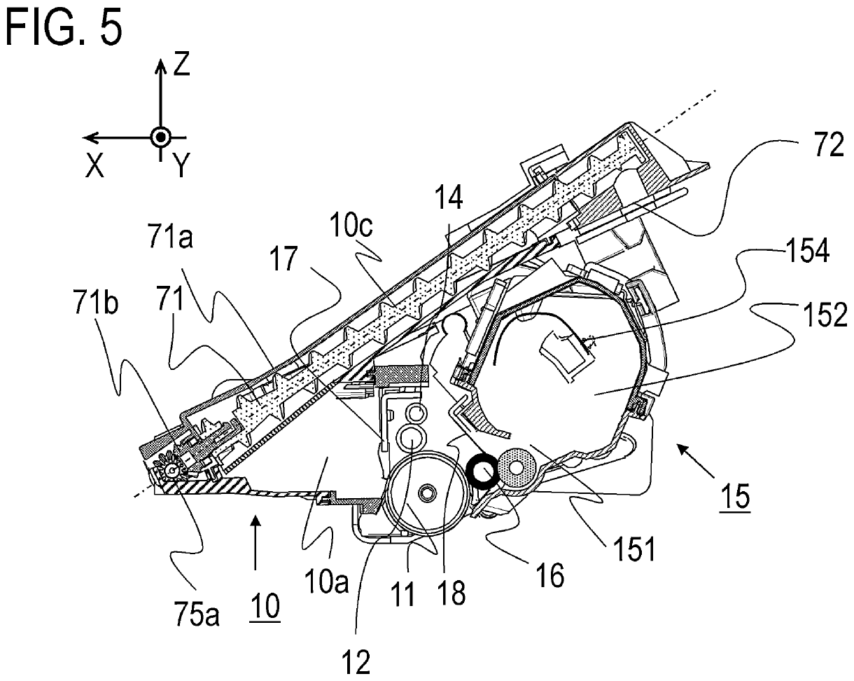

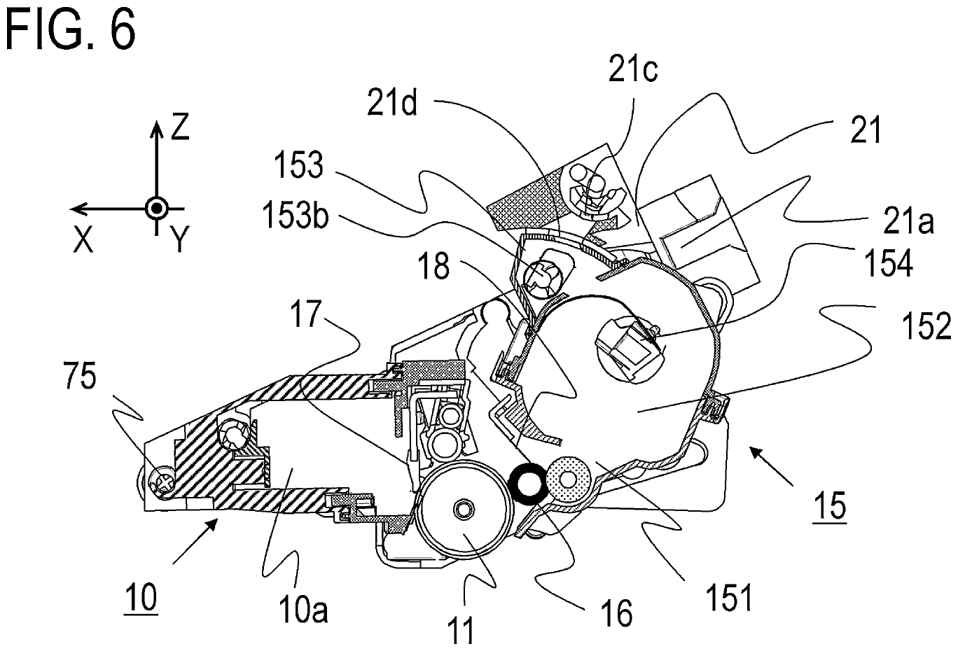

The process cartridge B according to Embodiment 1 will be described in further detail with reference to FIGS. 3 to 6. First, an internal configuration of the process cartridge B will be described. FIG. 3 is a frontal view, viewing the process cartridge B in an orientation of being attached to the printer main body A, from a rear face side of the printer main body A toward a front face side thereof, and illustrates an external appearance of the process cartridge B. FIG. 4 is a cross-sectional view taken along line a-a in FIG. 3, illustrating a cross-section orthogonal to a longitudinal direction of the process cartridge B. FIG. 5 is a cross-sectional view taken along line b-b in FIG. 3 that passes through a second waste toner transport path 10c, illustrating a cross-section orthogonal to the longitudinal direction of the process cartridge B. FIG. 6 is a cross-sectional view taken along line c-c in FIG. 3 that passes through a replenishing port 21c of the process cartridge B, illustrating a cross-section orthogonal to the longitudinal direction of the process cartridge B. Note that the longitudinal direction of the process cartridge B is parallel to a rotation axial line direction of the photosensitive drum 11, the developing roller 16, and so forth.

Hereinafter, X, Y, and Z directions are defined on the basis of orientation of the process cartridge B and the toner cartridge C in a state of being attached to the printer main body A. The Y direction is a direction parallel to the longitudinal direction of the process cartridge B and the toner cartridge C, the Z direction is the vertical direction (gravitational direction), and the X direction is a direction orthogonal to the Z direction and the Y direction.

The process cartridge B is made up of a cleaning unit 10 (first unit) and a developing unit 15 (second unit). The cleaning unit 10 includes the photosensitive drum 11, and can be deemed to be a photosensitive unit as well. The developing unit 15 serving as a developing portion includes the developing roller 16 serving as developing means bearing the developer, and supplies the toner serving as the developer to the photosensitive drum 11 of the cleaning unit 10.

The cleaning unit 10 has the photosensitive drum 11, a cleaning blade 17 serving as a cleaning member of the photosensitive drum 11, the charging roller 12 serving as the charging member, and a charging roller cleaner 14 serving as a cleaning member of the charging roller 12. Also, a waste toner accommodating portion 10a, a first waste toner transport path 10b, and the second waste toner transport path 10c, are formed in the cleaning unit 10.

The charging roller 12 is disposed so as to come into contact with an outer peripheral face of the photosensitive drum 11. The charging roller 12 charges the photosensitive drum 11 by voltage being applied from a high-voltage power source that is omitted from illustration. Also, the charging roller 12 rotates following rotation of the photosensitive drum 11 that rotates.

The cleaning blade 17 is a member that has elasticity, and is disposed so as to come into contact with the outer peripheral face of the photosensitive drum 11. By a distal end thereof elastically coming into contact with the photosensitive drum 11, the cleaning blade 17 removes toner remaining on the surface of the photosensitive drum 11, from the surface of the photosensitive drum 11, following the sheet S passing between the photosensitive drum 11 and the transfer roller 104. The toner that is removed (waste toner) is transported to the toner cartridge C from the waste toner accommodating portion 10a, via the first waste toner transport path 10b and the second waste toner transport path 10c.

As illustrated in FIG. 6, the developing unit 15 has a developing frame body 503 to which the developing roller 16 is rotatably attached, and a developing blade 18 is fixed. The developing frame body 503 has a developing chamber 151 in which the developing roller 16 is disposed, a toner accommodating chamber 152 that supplies toner to the developing chamber 151, and a toner accepting chamber 153 that accepts toner supplied from the toner cartridge C, as a toner accommodating portion. The developing roller 16 supplies toner to a developing region of the photosensitive drum 11 to develop an electrostatic latent image formed on the photosensitive drum 11. The developing blade 18 abuts a peripheral face of the developing roller 16 to regulate the amount of toner adhering to the peripheral face of the developing roller 16. The developing blade 18 also imparts the toner with a frictional charge.

A stirring member 154 is rotatably provided inside the toner accommodating chamber 152. The toner accommodated within the toner accommodating chamber 152 is fed to the developing chamber 151 by rotation of the stirring member 154, and is supplied to the developing roller 16.

The remaining amount of the toner within the toner accommodating chamber 152 is sensed by a remaining toner amount sensing unit. The remaining toner amount sensing unit will be described in detail later. When the amount of toner within the toner accommodating chamber 152 is no more than a predetermined amount, toner is supplied from the toner cartridge C to the process cartridge B as appropriate. The toner supplied to the developing unit 15 is accepted in the toner accepting chamber 153 through the replenishing port 21c and a handover port 21d of a stay 21 of the process cartridge B, and thereafter is accommodated in the toner accommodating chamber 152.

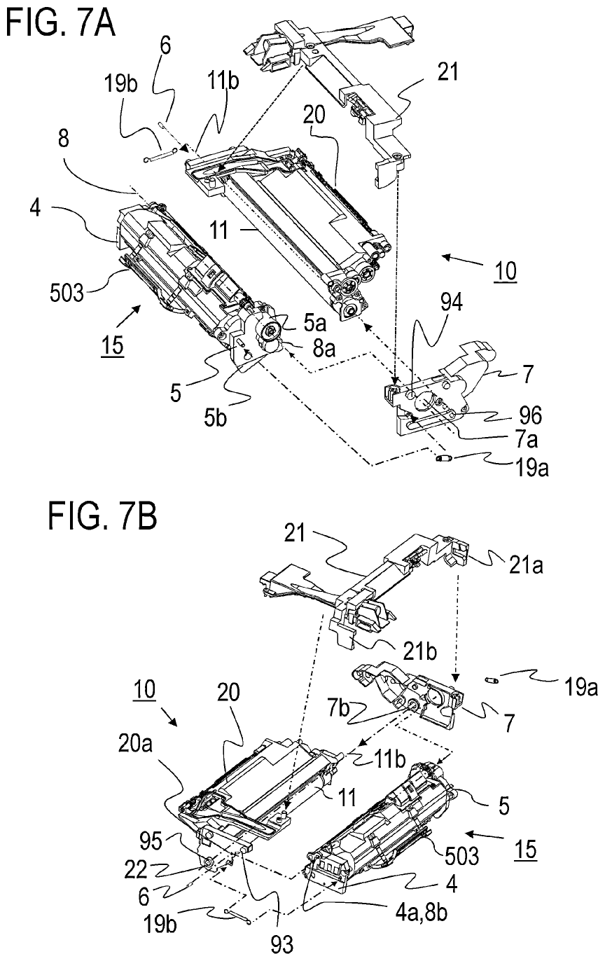

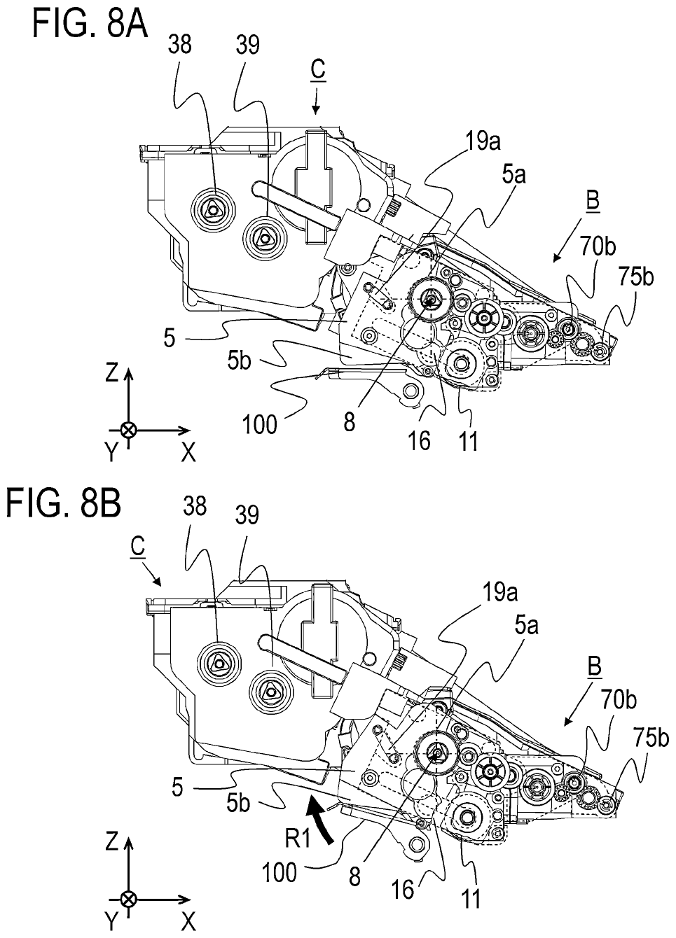

The configuration of the process cartridge B according to Embodiment 1 will be described in further detail with reference to FIGS. 4, 7A, 7B, 8A, and 8B. FIGS. 7A and 7B are disassembled perspective views of the process cartridge B. FIG. 7A is a diagram viewing the process cartridge B from one end side in the longitudinal direction, and FIG. 7B is a diagram viewing the process cartridge B from the other end side in the longitudinal direction. FIGS. 8A and 8B are schematic side views illustrating an abutting state and a spaced state of the developing unit 15 as to the photosensitive drum 11 in the process cartridge B, and are diagrams viewing the process cartridge B in the longitudinal direction. FIG. 8A illustrates a state in which the developing roller 16 of the developing unit 15 is abutting the photosensitive drum 11, and FIG. 8B illustrates a state in which the developing roller 16 of the developing unit 15 is separated from the photosensitive drum 11.

As illustrated in FIGS. 7A and 7B, the cleaning unit 10 is made up of a cleaning frame body 20, the stay 21, and a side cover 7. The cleaning frame body 20 supports the cleaning blade 17, the charging roller 12, and the charging roller cleaner 14. One end portion of the photosensitive drum 11 in the rotation axial line direction is rotatably supported by a drum pin 22 attached to the cleaning frame body 20, and another end portion thereof by a photosensitive drum supporting portion 7b provided to the side cover 7.

On respective end portions of the developing unit 15 in the longitudinal direction (rotation axial line direction of the developing roller 16) are disposed bearing members 4 and 5. The developing unit 15 is joined to the cleaning unit 10 so as to be pivotable about a pivoting axial line 8 that is defined by a straight line including spindles 8a and 8b. The pivoting axial line 8 is an axial line parallel to a rotation axial line 11b of the photosensitive drum 11.

The configuration in which the developing unit 15 is supported by the cleaning unit 10 will be described in detail. As illustrated in FIG. 7A, the bearing member 5 has a cylindrical form 5a that is supported by a cylindrical hole form 7a provided in the side cover 7 of the cleaning unit 10. The spindle 8a is defined by a common axial line between the cylindrical hole form 7a of the side cover 7 and the cylindrical form 5a of the bearing member 5.

Also, as illustrated in FIG. 7B, a pin 6 is inserted so as to span a cylindrical hole form 20a of the cleaning frame body 20 and a cylindrical hole form 4a of the bearing member 4. The spindle 8b is defined by a common axial line between the pin 6 and the cylindrical hole form 4a of the bearing member 4. The spindle 8a and the spindle 8b are disposed substantially coaxially, and the pivoting axial line 8 is defined by a straight line including the spindle 8a and the spindle 8b, as described above.

According to the above configuration, the developing unit 15 is supported to be pivotable about the pivoting axial line 8 with respect to the cleaning unit 10. Biasing force of a pressuring spring 19a and a pressuring spring 19b, which are elastic members, acts between the developing unit 15 and the cleaning unit 10, such that the developing roller 16 abuts the photosensitive drum 11 under this biasing force.

An upper boss 93 and a lower boss 95 are provided on one end portion of the process cartridge B in the longitudinal direction, and an upper boss 94 and a lower boss 96 are provided on the other end portion thereof. These function as guided portions for when attaching the process cartridge B to the printer main body A. Also, a toner cartridge positioning portion 21a and a toner cartridge positioning portion 21b are provided on the stay 21 of the process cartridge B. These positioning portions 21a and 21b are provided for positioning the process cartridge B with respect to the toner cartridge C.

Abutting and separating operations of the developing unit 15 with respect to the cleaning unit 10 will be described with reference to FIGS. 8A and 8B. Note that the side cover 7 is omitted from illustration in FIGS. 8A and 8B, in order to illustrate a separating mechanism 100 of the printer main body A.

A protruding portion 5b is provided on the bearing member 5. In a state in which the developing roller 16 is abutted against the photosensitive drum 11, the protruding portion 5b is at a position not abutting the separating mechanism 100, as illustrated in FIG. 8A. Positions of the developing roller 16 and the photosensitive drum 11 at this time are at an image forming position in which the developing roller 16 develops the electrostatic latent image formed on the surface of the photosensitive drum 11.

Conversely, as illustrated in FIG. 8B, when the separating mechanism 100 provided to the printer main body A moves and abuts the protruding portion 5b, the protruding portion 5b is subjected to force from the separating mechanism 100. The developing unit 15 then pivots in an arrow R1 direction with the pivoting axial line 8 as the center of pivoting, and the photosensitive drum 11 is separated from the developing roller 16. Positions of the developing roller 16 and the photosensitive drum 11 at this time are at a non-image forming position, in which the positions of the developing roller 16 and the photosensitive drum 11 are retracted from the image forming position.

When the separating mechanism 100 returns to the original position before abutting the protruding portion 5b and moves away from the protruding portion 5b, the developing unit 15 is subjected to biasing force in an opposite direction from the arrow R1 direction, by the pressuring spring 19a and the pressuring spring 19b. The developing unit 15 pivots in the opposite direction as the arrow R1 direction under action of this biasing force, and the developing roller 16 and the photosensitive drum 11 abut.

According to the above configuration, the orientation of the developing unit 15 in the process cartridge B is changed by the separating mechanism 100, and the abutting position (image forming position) of the photosensitive drum 11 and the developing roller 16, and the separated positions thereof (non-image forming position) are switched. Thus, deterioration of toner and unnecessary toner consumption when not forming images can be suppressed.

### Toner Cartridge C

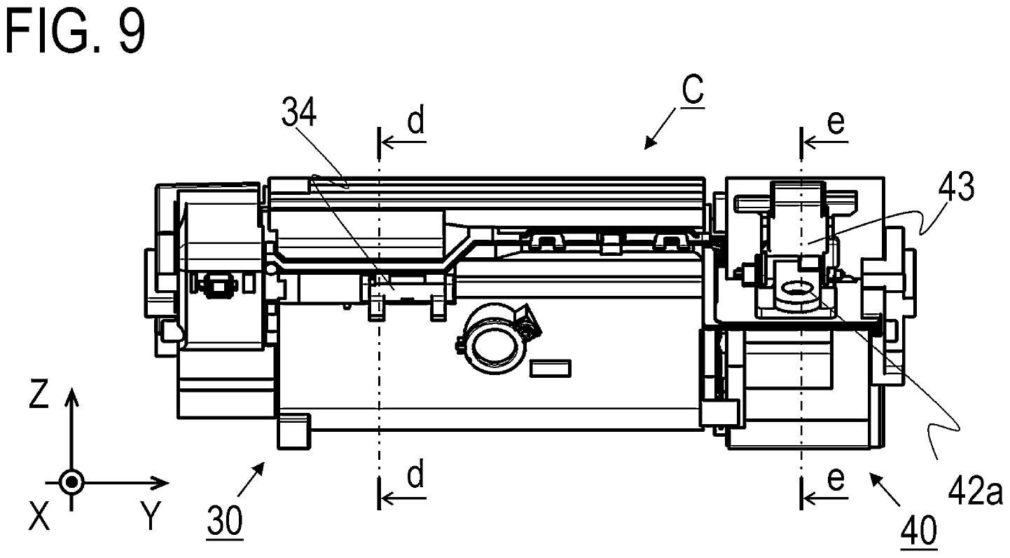

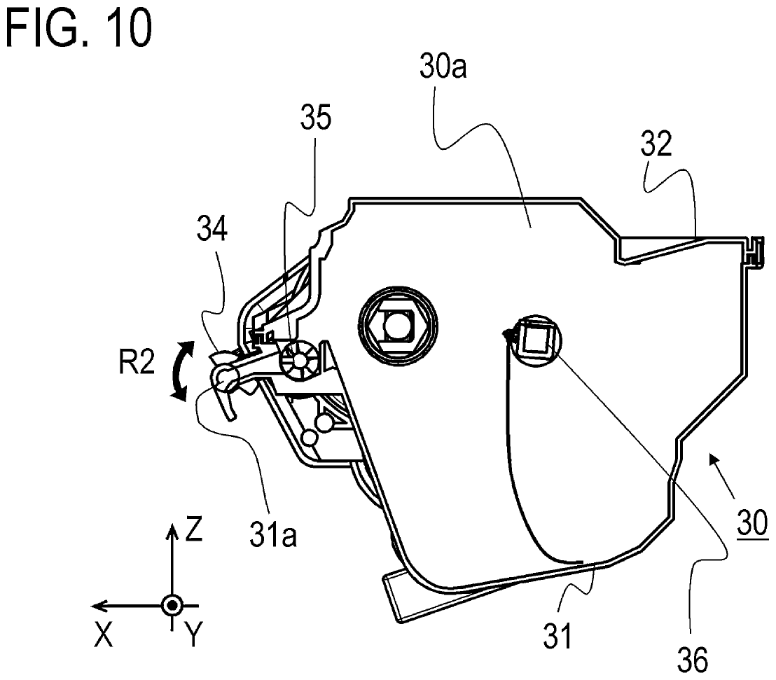

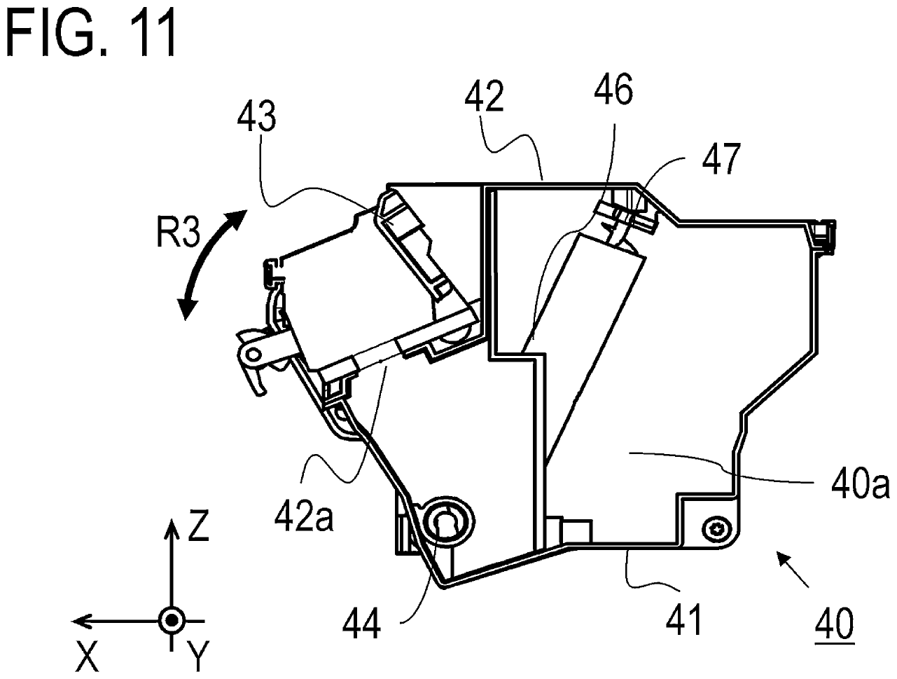

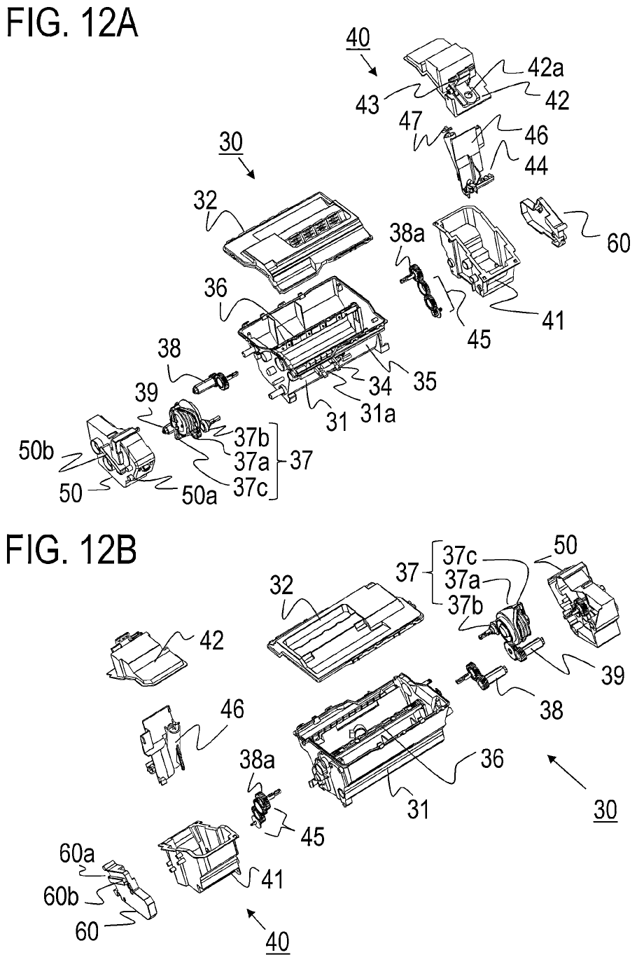

The toner cartridge C according to Embodiment 1 will be described in further detail with reference to FIGS. 9 to 12A and 12B. FIG. 9 is a frontal view, viewing the toner cartridge C in an orientation of being attached to the printer main body A, from a rear face side of the printer main body A toward a front face side thereof, and illustrates an external appearance of the toner cartridge C. FIG. 10 is a cross-sectional view taken along line d-d in FIG. 9, illustrating a cross-section orthogonal to the longitudinal direction of the toner cartridge C that passes through a toner supply unit 30. FIG. 11 is a cross-sectional view taken along line e-e in FIG. 9, illustrating a cross-section orthogonal to the longitudinal direction of the toner cartridge C, passing through a waste toner recovery unit 40. FIGS. 12A and 12B are disassembled perspective views of the toner cartridge C. FIG. 12A is a diagram viewing the toner cartridge C from one end side in the longitudinal direction, and FIG. 12B is a diagram viewing the toner cartridge C from the other end side in the longitudinal direction. Note that the longitudinal direction of the toner cartridge C is parallel to the rotation axial line direction of the photosensitive drum 11 and so forth, in a state in which the process cartridge B and the toner cartridge C are attached to the printer main body A.

As illustrated in FIGS. 10 and 11, the toner cartridge C has the toner supply unit 30 that supplies toner to the process cartridge B and the waste toner recovery unit 40 that recovers waste toner from the process cartridge B. The toner supply unit 30 and the waste toner recovery unit 40 are disposed adjacent to each other in the longitudinal direction of the toner cartridge C.

As illustrated in FIG. 10, the toner supply unit 30 has a supply unit frame body 31 and a supply unit lid 32. A toner accommodating portion 30a that accommodates toner therein is formed in the toner supply unit 30 by the supply unit frame body 31 and the supply unit lid 32. A toner discharge port 31a for discharging toner from the toner accommodating portion 30a is formed in the supply unit frame body 31, and a shutter member 34 is provided, configured so as to be capable of opening and closing the toner discharge port 31a outside of the supply unit frame body 31. The shutter member 34 opens and closes by rotating in an arrow R2 direction in conjunction with the toner cartridge C being attached.

The toner accommodating portion 30a has a screw member 35 that transports the toner toward the toner discharge port 31a, and a stirring and transporting unit 36 that transports the toner toward the screw member 35. The toner transported to the toner discharge port 31a is discharged from the toner discharge port 31a by change in volume of a pump 37a that will be described later.

As illustrated in FIGS. 12A and 12B, the toner supply unit 30 has a pump unit 37. The pump unit 37 has the pump 37a that changes volume by expanding and contracting, a cam 37b that causes the pump 37a to expand and contract by rotating, and a link arm 37c.

The toner supply unit 30 further has a stirring drive input unit 38 that drives the stirring and transporting unit 36, and a pump-and-screw drive input unit 39 that drives the pump unit 37 and the screw member 35.

As illustrated in FIG. 11, a waste toner accommodating portion 40a of the waste toner recovery unit 40 is formed by a waste toner accommodating frame body 41 and a waste toner accommodating lid 42. A waste toner accepting inlet 42a is provided to the waste toner accommodating lid 42. The waste toner recovery unit 40 has a waste toner shutter member 43 that opens and closes the waste toner accepting inlet 42a. The waste toner shutter member 43 is opened and closed in an arrow R3 direction in conjunction with the attaching and detaching of the toner cartridge C to and from the printer main body A.

As illustrated in FIGS. 11 and 12A, a partitioning member 46, a first waste toner accommodating screw 44, and a second waste toner accommodating screw 47 are disposed inside the waste toner recovery unit 40. The first waste toner accommodating screw 44 transports waste toner falling down from the waste toner accepting inlet 42a in the longitudinal direction of the toner cartridge C. Driving force is transmitted to the second waste toner accommodating screw 47 from the first waste toner accommodating screw 44, and the second waste toner accommodating screw 47 transports the waste toner transported by the first waste toner accommodating screw 44 obliquely upward.

A driving mechanism for the waste toner recovery unit 40 will be described. Driving force input by the stirring drive input unit 38 of the toner supply unit 30 is transmitted to a non-driving-side gear 38a provided on a non-driving-side of the toner supply unit 30, via the stirring and transporting unit 36. The driving force is then transmitted from the non-driving-side gear 38a to the first waste toner accommodating screw 44, via a waste toner accommodating portion geartrain 45.

A driving-side side cover 50 is attached to an end portion of the toner cartridge C on the toner supply unit 30 side, and a non-driving-side side cover 60 is attached on the end portion thereof on the waste toner recovery unit 40 side. The driving-side side cover 50 has a positioning boss 50a and a guided portion 50b. The non-driving-side side cover 60 has a positioning boss 60a and a guided portion 60b, in the same way. The guided portions 50b and 60b function as guided portions when attaching the toner cartridge C to the printer main body A. The positioning bosses 50a and 60a are provided for positioning the toner cartridge C with respect to the process cartridge B.

According to the above configuration, the stirring drive input unit 38 can be driven even when the pump-and-screw drive input unit 39 is not driven. That is to say, even when the toner supply unit 30 is not replenishing the process cartridge B with toner, a waste toner recoverable state can be maintained by driving the first waste toner accommodating screw 44 and the second waste toner accommodating screw 47 within the waste toner recovery unit 40.

Also, according to the configuration of Embodiment 1, driving force can be input from the printer main body A to one end portion of the toner cartridge C in the longitudinal direction, and accordingly the geartrain configuration of the printer main body A can be simplified. Also, transmitting driving force from one end portion of the supply unit frame body 31 to the other end portion thereof by using the stirring and transporting unit 36 enables driving force to be transmitted to the waste toner recovery unit 40 without increasing the number of parts for transmitting driving force. According to such a configuration, the waste toner can be accommodated in the toner cartridge C by the driving means of the toner cartridge C, while suppressing increase in size of the toner cartridge C and the printer main body A.

### Method of Attaching and Detaching Process Cartridge B and Toner Cartridge C

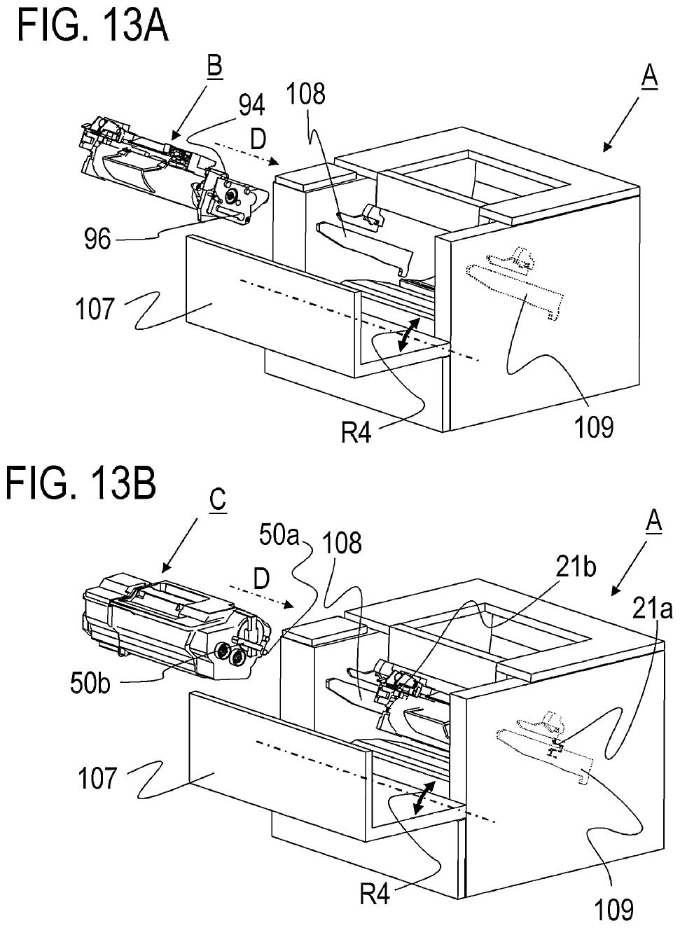

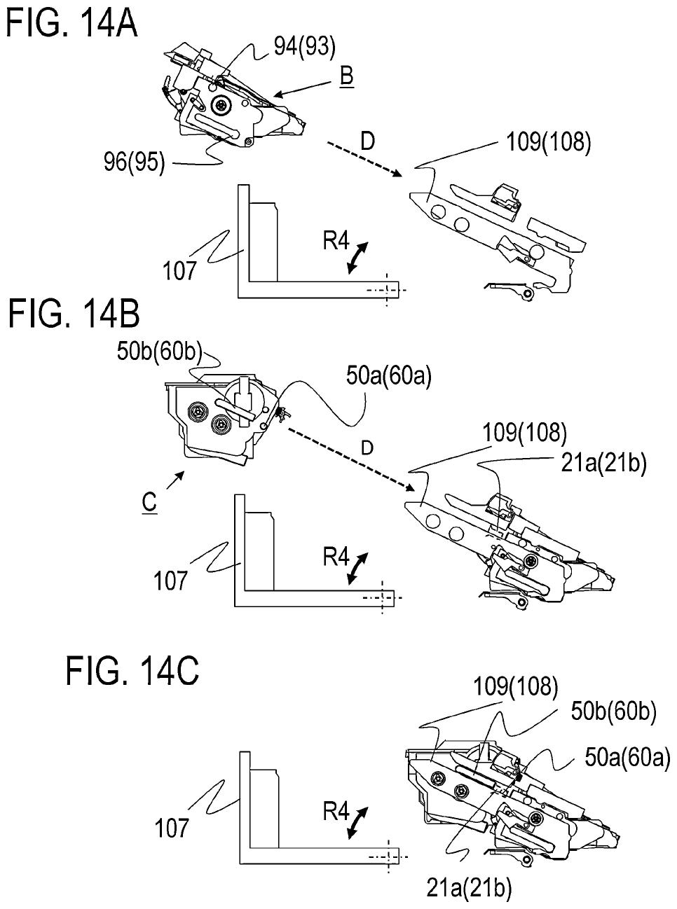

A method of attaching and detaching the process cartridge B and the toner cartridge C to and from the printer main body A will be described with reference to FIGS. 7A, 7B, 12A, 12B, 13A, 13B, 14A to 14C. FIGS. 13A and 13B are schematic perspective views illustrating a method of attaching of the process cartridge B and the toner cartridge C to the printer main body A. FIG. 13A illustrates the way in which the process cartridge B is attached to the printer main body A, and FIG. 13B illustrates the way in which the toner cartridge C is attached to the printer main body A. FIGS. 14A to 14C are schematic side views illustrating a method of attaching of the process cartridge B and the toner cartridge C to the printer main body A. FIG. 14A illustrates the way in which the process cartridge B is attached to the printer main body A, FIG. 14B illustrates the way in which the toner cartridge C is attached to the printer main body A (the printer main body A to which the process cartridge B has been attached), and FIG. 14C illustrates a state in which both of the process cartridge B and the toner cartridge C are attached to the printer main body A.

As illustrated in FIG. 13A, there are formed spaces (attaching spaces) inside the printer main body A for the process cartridge B and the toner cartridge C that are attached to be situated. An opening/closing door 107 is provided so as to be pivotable in arrow R4 direction with respect to the printer main body A, about the pivoting axial line, and FIG. 13A illustrates a state in which the opening/closing door 107 is open.

The printer main body A has guiding portions 108 and 109 for guiding the process cartridge B and the toner cartridge C. As illustrated in FIG. 7B, the process cartridge B has the upper boss 93 and the lower boss 95 on one end portion thereof in the longitudinal direction, and the upper boss 94 and the lower boss 96 on the other end portion thereof, as illustrated in FIG. 7A. The toner cartridge C has the positioning boss 50a and the guided portion 50b on one end portion thereof in the longitudinal direction, as illustrated in FIG. 12A, and has the positioning boss 60a and the guided portion 60b on the other end portion thereof, as illustrated in FIG. 12B. The positioning bosses 50a and 60a are provided on a downstream side (forward side) from the guided portions 50b and 60b, in an attaching direction of the toner cartridge C.

First, a method of attaching the process cartridge B to the printer main body A will be described. The process cartridge B is inserted into the printer main body A in a state in which the upper boss 93 and the lower boss 95 have the guiding portion 108 of the printer main body A interposed therebetween, and also the upper boss 94 and the lower boss 96 have the guiding portion 109 of the printer main body A interposed therebetween. Due to this insertion method, the process cartridge B is inserted in an arrow direction D while being guided by the guiding portions 108 and 109.

Next, a method of attaching the toner cartridge C to the printer main body A will be described. The toner cartridge C is attached to the printer main body A following the process cartridge B having been attached to the printer main body A. As illustrated in FIG. 7B, the stay 21 of the process cartridge B has the toner cartridge positioning portion 21a and the toner cartridge positioning portion 21b, for positioning of the toner cartridge C.

The toner cartridge C is inserted into the printer main body A in a state in which the guided portion 50b is riding on the guiding portion 109, and also in which the guided portion 60b is riding on the guiding portion 108. Due to this insertion method, the toner cartridge C is inserted in the arrow direction D while being guided by the guiding portions 108 and 109.

As illustrated in FIG. 14C, once the toner cartridge C is attached to an insertion completion position, the positioning boss 50a and the positioning boss 60a are inside the toner cartridge positioning portion 21a and the toner cartridge positioning portion 21b. At this time, distal end portions of the guided portion 50b and the guided portion 60b in an insertion direction are away from the guiding portion 108 and the guiding portion 109, and rear end portions thereof are in a state abutting the guiding portion 108 and the guiding portion 109. Thus, the toner cartridge C is positioned with respect to the process cartridge B. Also, the positioning of the toner cartridge C within the printer main body A is performed by the rear end portions of the guided portion 50b and the guided portion 60b abutting the guiding portion 108 and the guiding portion 109.

Thereafter, closing the opening/closing door 107 following insertion of the process cartridge B and the toner cartridge C places the image forming apparatus P in a state of being capable of forming images. Detaching the toner cartridge C and the process cartridge B from the printer main body A is performed by reverse procedures from those described above.

### Remaining Toner Amount Sensing Portion

A remaining toner amount sensing portion is provided in the image forming apparatus P according to the Present Embodiment, for sensing the remaining amount of toner in the toner accommodating chamber 152 serving as the toner accommodating portion of the process cartridge B. The remaining toner amount sensing portion according to the Present Embodiment is a light-transmitting type remaining amount sensing portion, and is generally made up of a light-emitting portion and a light-receiving portion provided to the printer main body A, and a light-transmitting portion provided to a frame body of the process cartridge B.

### Description of Light-Transmitting Portion (Light Guide)

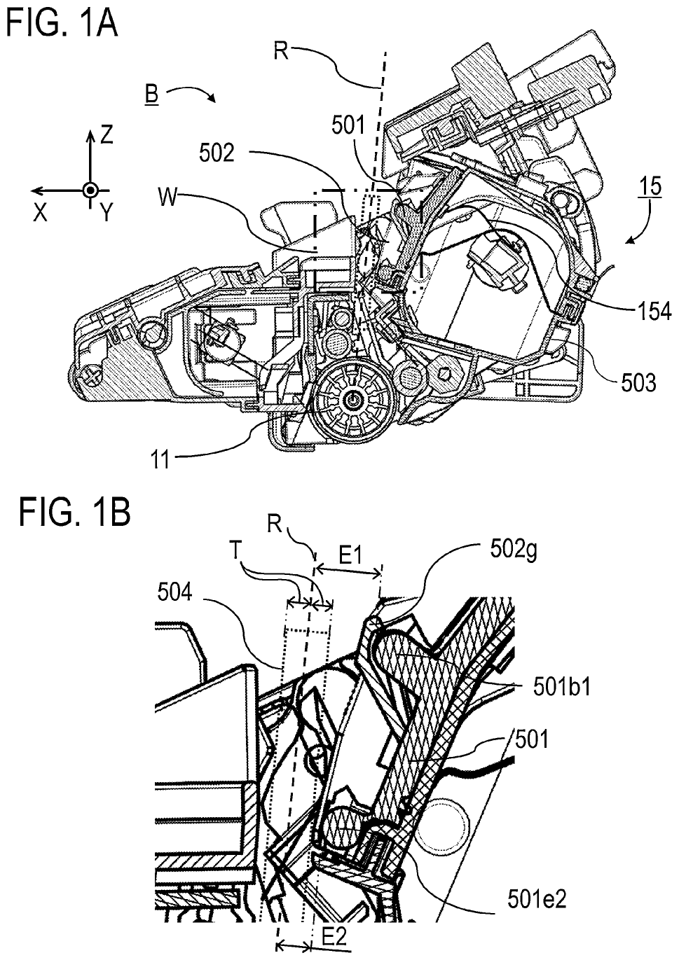

A configuration of the light-transmitting portion of the process cartridge B, out of the configuration of the remaining toner amount sensing portion according to the Present Embodiment, will be described with reference to FIGS. 15A, 15B, 1A, 1B, 16A, and 16B.

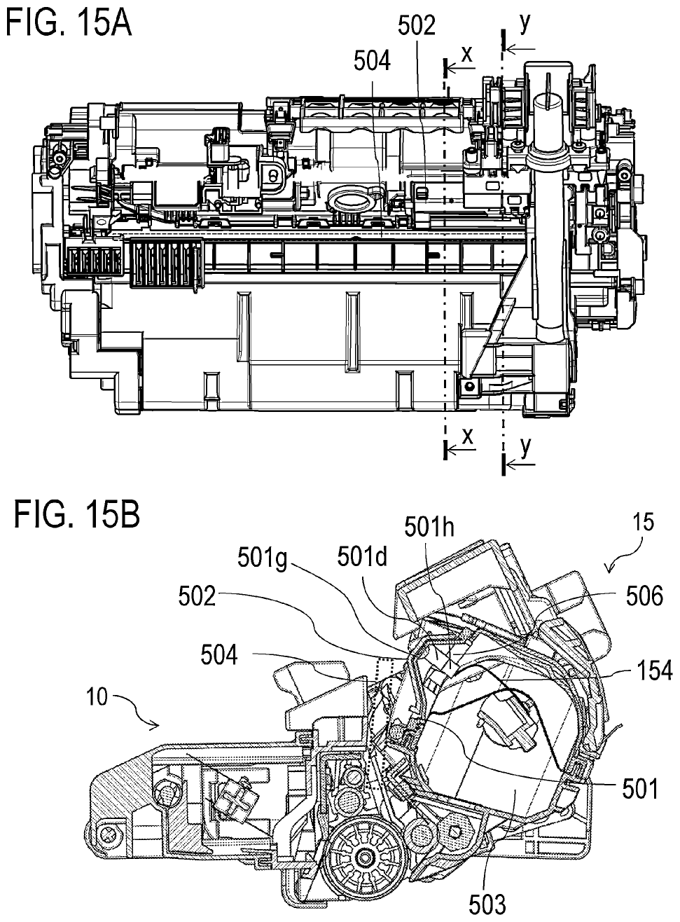

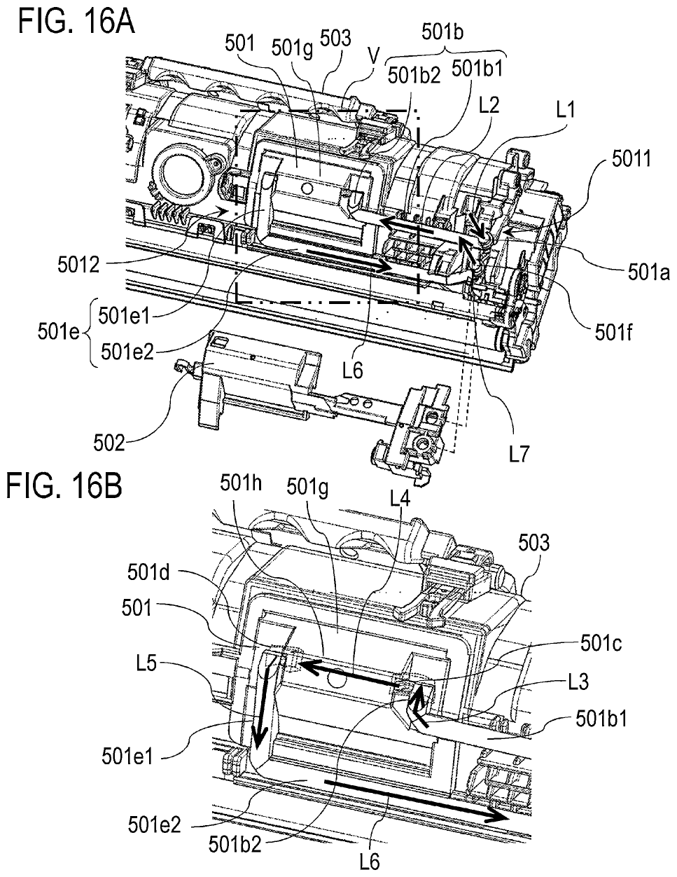

FIG. 15A illustrates the process cartridge B, as viewed from an opening direction of an opening portion 504 that is provided to the process cartridge B for passage of laser light from the laser scanner 101 toward the photosensitive drum 11. FIG. 15B is a cross-sectional view of a sensing portion 501g of a light guide 501 when viewing the process cartridge B in the longitudinal direction (cross-sectional view along x-x). FIG. 1A is a cross-sectional view of FIG. 15A taken along y-y, illustrating a light input portion 501a that is a light-incident portion of the light guide 501, and a light output portion 501f that is a light-exiting portion thereof. FIG. 1B is an enlarged view of a region W in FIG. 1A. FIG. 16A is a disassembled perspective view illustrating a light guide cover 502, which is a cover member, disassembled. FIG. 16B is an enlarged view of a region V illustrated in FIG. 16A.

The developing frame body 503 of the developing unit 15 of the process cartridge B is provided with the light guide 501 and the light guide cover 502 that covers part of the light guide 501. The light guide 501 is made of a material having light-transmitting properties (e.g., light-transmitting resin such as transparent acrylic or the like), and is integrally assembled with the developing frame body 503. The light guide 501 is a light-transmitting member in which a guide path for guiding sensing light is formed, and through which sensing light for sensing the remaining toner amount within the toner accommodating chamber 152 passes.

The guide path of the light guide 501 is made up of the light input portion 501a, a first input straight portion 501b1, a second input straight portion 501b2, an in-accommodation-chamber light-exiting face 501c, an in-accommodation-chamber light-receiving face 501d, a first output straight portion 501e1, a second output straight portion 501e2, the light output portion 501f, and so forth. The light guide 501 is a member in which the sensing portion 501g for forming a passage portion 501h within the toner accommodating chamber 152 is integrally configured, besides the other portions making up the guide path described above.

More specifically, the guide path of the light guide 501 is made up of a first lightguide portion 5011 that guides sensing light to the toner accommodating portion of the developing frame body 503, and a second lightguide portion 5012 that guides the sensing light that has passed through the toner accommodating portion to the light-receiving portion.

The first lightguide portion 5011 has the light input portion 501a that takes in sensing light from outside of the developing frame body 503, as a first incident portion. In the Present Embodiment, sensing light emitted from an LED 451a serving as the light-emitting portion provided to the printer main body A enters the light input portion 501a. Also, the first lightguide portion 5011 has the in-accommodation-chamber light-exiting face 501c that causes incident sensing light from the light input portion 501a to be exited toward the inside of the toner accommodating portion, as a first exiting portion. The toner accommodating portion is made up of the developing chamber 151, the toner accommodating chamber 152, the toner accepting chamber 153, and so forth, and in the Present Embodiment, the sensing light enters the toner accommodating chamber 152 from the in-accommodation-chamber light-exiting face 501c. Also, the first lightguide portion 5011 has a first guiding portion 501b that connects between the light input portion 501a and the in-accommodation chamber light-exiting face 501c. The first guiding portion 501b includes the first input straight portion 501b1 as a first straight advance portion, and the second input straight unit 501b2 that is orthogonal to the first input straight portion 501b1. The sensing light is guided from the light input portion 501a to the in-accommodation-chamber light-exiting face 501c, via the first input straight portion 501b1, the second input straight portion 501b2, and so forth.

The second lightguide portion 5012 has, as a second incident portion, the in-accommodation-chamber light-receiving face 501d, to which sensing light that has passed through the toner accommodating chamber 152 serving as the inside of the toner accommodating portion, enters. The second lightguide portion 5012 also has, as a second exiting portion, the light output portion 501f that causes the sensing light that has entered the in-accommodation-chamber light-receiving face 501d to be exited toward the outside of the developing frame body 503. In the Present Embodiment, the light output portion 501f causes sensing light to be exited toward a phototransistor 451b serving as a light-receiving portion and also as a sensing portion, provided to the printer main body A. The second lightguide portion 5012 also has a second guiding portion 501e that connects between the in-accommodation-chamber light-receiving face 501d and the light output portion 501f. The second guiding portion 501e includes the first output straight portion 501e1, and the second output straight portion 501e2 that is orthogonal to the first output straight portion 501e1, as a second straight advance portion. The sensing light is guided from the in-accommodation-chamber light-receiving face 501d to the light output portion 501f via the first output straight portion 501e1 and the second output straight portion 501e2.

The light input portion 501a of the first lightguide portion 5011 and the light output portion 501f of the second lightguide portion 5012 are each disposed at one end (first end portion) of the developing frame body 503 in the direction of the rotation axial line of the developing roller 16 (longitudinal direction of developing frame body 503). The light input portion 501a and the light output portion 501f are disposed at substantially the same position with respect to the longitudinal-direction position, and so as to be arrayed in a direction orthogonal to the longitudinal direction. The light output portion 501f is disposed at a position closer to a passage region of laser light from the laser scanner 101 that will be described later, than the light input portion 501a. Also, the light output portion 501f is disposed at a position closer to the photosensitive drum 11 than the light input portion 501a.

The in-accommodation-chamber light-exiting face 501c of the first lightguide portion 5011 and the in-accommodation-chamber light-receiving face 501d of the second lightguide portion 5012 are each disposed further toward another end (second end portion) in the longitudinal direction that is opposite to the above one end (first end portion) than the light input portion 501a and the light output portion 501f. The in-accommodation-chamber light-exiting face 501c is at a position closer to the above one end (first end portion) than the in-accommodation-chamber light-receiving face 501d, and the in-accommodation-chamber light-exiting face 501c and the in-accommodation-chamber light-receiving face 501d are disposed so as to be arrayed along the longitudinal direction. Also, the in-accommodation-chamber light-exiting face 501c and the in-accommodation-chamber light-receiving face 501d are disposed at different positions from the light input portion 501a and the light output portion 501f in the direction orthogonal to the longitudinal direction. The in-accommodation-chamber light-exiting face 501c and the in-accommodation-chamber light-receiving face 501d are disposed at positions farther from the passage region of laser light from the laser scanner 101 that will be described later, than the light input portion 501a and the light output portion 501f. The in-accommodation-chamber light-exiting face 501c and the in-accommodation-chamber light-receiving face 501d are also disposed at positions farther from the photosensitive drum 11 than the light input portion 501a and the light output portion 501f.

The first guiding portion 501b includes the first input straight portion 501b1 and the second input straight portion 501b2, so as to connect between the light input portion 501a and the in-accommodation-chamber light-exiting face 501c that are at different positions, as described above. The first input straight portion 501b1 extends along the longitudinal direction as the first straight advance portion, on the downstream side of the light input portion 501a on a lightguide path of the first guiding portion 501b. The second input straight portion 501b2 extends along the direction orthogonal to the longitudinal direction on the downstream side of the first input straight portion 501b1 on the lightguide path of the first guiding portion 501b.

In the same way, the second guiding portion 501e includes the first output straight portion 501e1 and the second output straight portion 501e2, so as to connect between the in-accommodation-chamber light-receiving face 501d and the light output portion 501f that are at different positions, as described above. The first output straight portion 501e1 extends along the direction orthogonal to the longitudinal direction on the downstream side of the in-accommodation-chamber light-receiving face 501d on a lightguide path of the second guiding portion 501e. The second output straight portion 501e2 extends, as the second straight advance portion, along the longitudinal direction on the downstream side of the first output straight portion 501e1 on the lightguide path of the second guiding portion 501e.

The first input straight portion 501b1 of the first guiding portion 501b and the second output straight portion 501e2 of the second guiding portion 501e extend arrayed in the direction orthogonal to the longitudinal direction. The length of the second output straight portion 501e2 in the longitudinal direction is longer than the length of the first input straight portion 501b1 in the longitudinal direction.

The passage portion 501h provided within the toner accommodating chamber 152 is situated between the in-accommodation-chamber light-exiting face 501c and the in-accommodation-chamber light-receiving face 501d. The passage portion 501h is space within the toner accommodating chamber 152 that is surrounded by the sensing portion 501g of the light guide 501. That is to say, part of a wall portion of the developing frame body 503 forming the toner accommodating chamber 152 is made up of the sensing portion 501g that serves as a part of the light guide 501.

Sensing light exiting from the in-accommodation-chamber light-exiting face 501c passes through the passage portion 501h and enters the in-accommodation-chamber light-receiving face 501d. The passage portion 501h is a sensed region for sensing to be performed by the sensing light, and is interposed between the in-accommodation-chamber light-exiting face 501c and the in-accommodation-chamber light-receiving face 501d in a direction along the longitudinal direction in the toner accommodating chamber 152. The sensing light exiting from the in-accommodation-chamber light-exiting face 501c enters the in-accommodation-chamber light-receiving face 501d, with the reception level thereof having been affected by the state of toner (amount of toner) accommodated in the toner accommodating chamber 152 (passage portion 501h).

As illustrated in FIGS. 1A and 1B, a linear route over which laser light emitted by the laser scanner 101 on the basis of image information ideally passes is defined as a laser route R, and a region (passage region) offset from the laser route R by a predetermined distance T as the opening portion 504. The light guide 501 is disposed at a position near to the opening portion 504, at a position between the toner accommodating chamber 152 and the opening portion 504. The photosensitive drum 11 is irradiated by the laser light that is emitted from the laser scanner 101 and passes by the side of the first input straight portion 501b1 and the second output straight portion 501e2 of the light guide 501.

Now, in the Present Embodiment, the second output straight portion 501e2 is the part of the second lightguide portion 5012 of the light guide 501 that is closest to the passage region of laser light from the laser scanner 101. Also, the second output straight portion 501e2 is at a position closer to the passage region of laser light than any portion of the first lightguide portion 5011. Further, a direction in which the second output straight portion 501e2 extends is the direction along the rotation axial line of the photosensitive drum 11 and also is a direction along a scanning direction of laser light when the laser scanner 101 performs scanning exposure of the peripheral face of the photosensitive drum 11.

Also, as illustrated in FIG. 15B, a remaining amount sensing opening 506 is provided in the developing frame body 503 that is the frame body making up the toner accommodating chamber 152 of the developing unit 15. The guide path inside the light guide 501 communicates with the toner accommodating chamber 152 via the remaining amount sensing opening 506.

As illustrated in FIGS. 16A and 16B, the sensing light emitted from the light-emitting portion of the printer main body A is input to the light input portion 501a of the light guide 501, in an arrow L1 direction. The sensing light then advances while being reflected in an arrow L2 direction by the first input straight portion 501b1 and in an arrow L3 direction by the second input straight portion 501b2, and arrives at the inside of the toner accommodating chamber 152. Situated inside the toner accommodating chamber 152 of the light guide 501 are the in-accommodation chamber light-exiting face 501c that causes the sensing light to exit in an arrow LA direction, and the in-accommodation-chamber light-receiving face 501d that receives the sensing light exiting from the in-accommodation chamber light-exiting face 501c, along the longitudinal direction. In Embodiment 1, the arrow L2 direction (first direction) and the arrow LA direction are directions parallel to the longitudinal direction of the developing unit 15 (rotation axial line of developing roller 16) and the rotation axial line 11b of the photosensitive drum 11.

Sensing light advancing in the direction of the arrow L3 passes through the in-accommodation chamber light-exiting face 501c, and passes through the passage portion 501h inside the toner accommodating chamber 152. The sensing light that has passed through the passage portion 501h is reflected at the in-accommodation-chamber light-receiving face 501d, and advances through the first output straight portion 501e1 in an arrow L5 direction. The sensing light then advances while being reflected from the arrow L5 direction to an arrow L6 direction by the second output straight portion 501e2, and is made to exit in an arrow L7 direction toward the sensing portion provided to the printer main body A by the light output portion 501f. In Embodiment 1, the arrow L6 direction is the opposite direction (second direction) from the arrow L2 direction, and the arrow L7 direction is the opposite direction from the arrow L1 direction.

In this way, the sensing light enters the first lightguide portion 5011 of the light guide 501 from the light input portion 501a that is an entrance, passes through the first input straight portion 501b1 and the second input straight portion 501b2, and exits from the in-accommodation chamber light-exiting face 501c toward the passage portion 501h of the toner accommodating chamber 152. The sensing light exiting to the passage portion 501h then enters the second lightguide portion 5012 of the light guide 501 toward the in-accommodation-chamber light-receiving face 501d, passes through the first output straight portion 501e1 and the second output straight portion 501e2, and exits from the light output portion 501f. The remaining amount sensing according to Embodiment 1 is sensing of the toner amount in the toner accommodating chamber 152 in accordance with the duration of time of the sensing light being shielded by toner stirred by the stirring member 154 at the passage portion 501h.

### Description of Interface Portion as to Printer Main Body a

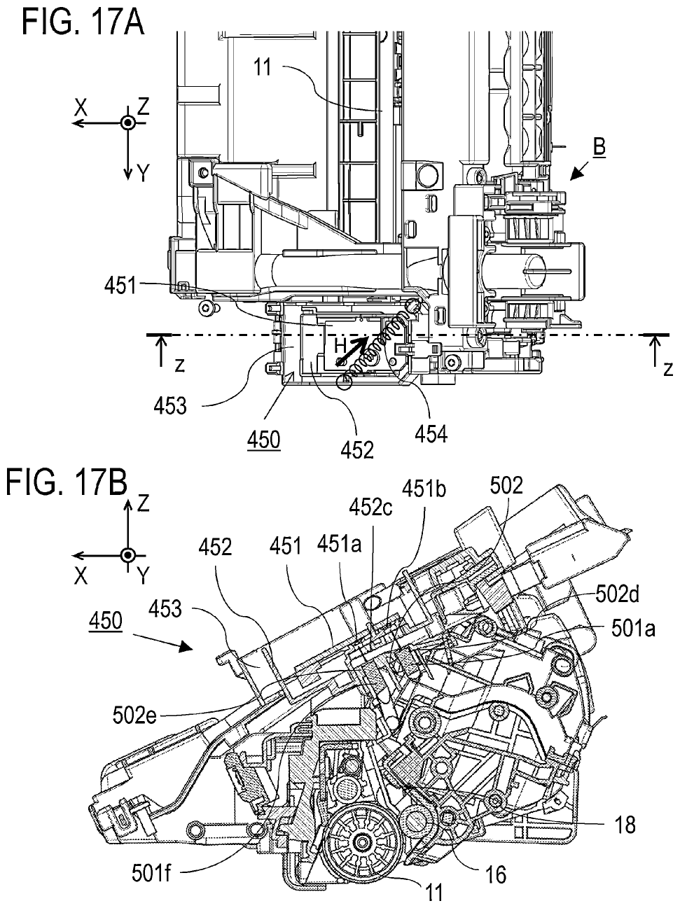

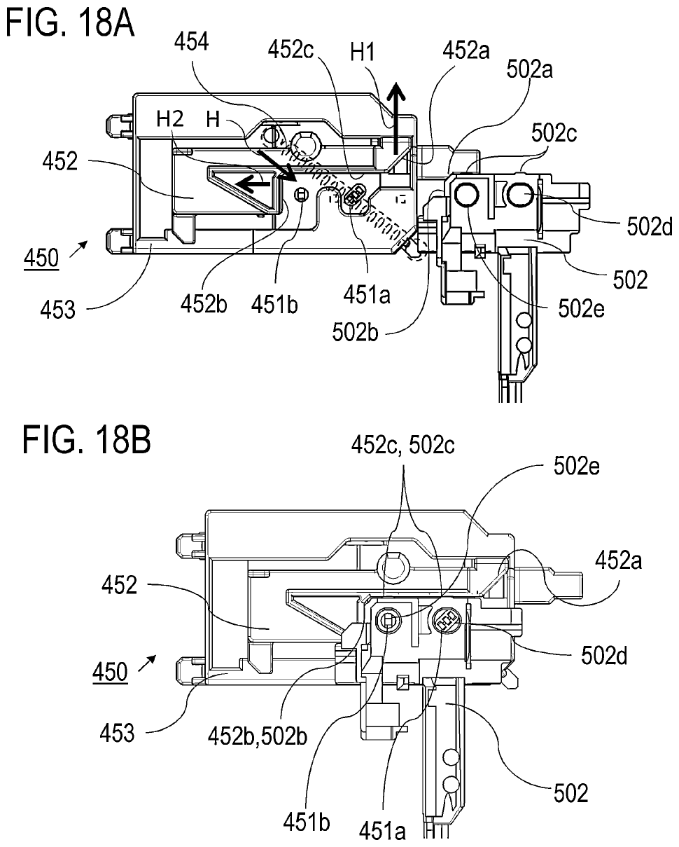

An interface portion of the printer main body A and the process cartridge B will be described with reference to FIGS. 17A, 17B, 18A, and 18B. FIGS. 17A and 17B are explanatory diagrams illustrating principal portions of the process cartridge B and the printer main body A in a state in which the process cartridge B is attached to the printer main body A. FIG. 17A is a top view illustrating an end portion of the process cartridge B. FIG. 17B is a cross-sectional view taken along z-z in FIG. 17A, which is a cross-section that passes through the light input portion 501a and the light output portion 501f of the light guide 501, and that is orthogonal to the longitudinal direction of the process cartridge B. FIGS. 18A and 18B are diagrams viewing the light guide cover 502 and a light unit 450 in an optical axis direction of sensing light exiting the light output portion 501f of the light guide 501 toward the printer main body A. FIG. 18A illustrates a state of the process cartridge B being partway attached to the printer main body A, and FIG. 18B illustrates a state following the process cartridge B being attached to the printer main body A.

As illustrated in FIGS. 17A and 17B, the printer main body A is provided with the light unit 450 making up the remaining toner amount sensing portion for sensing the toner amount in the toner accommodating chamber 152 of the process cartridge B. The light unit 450 has a remaining amount sensing board 451, a board holder 452 to which the remaining amount sensing board 451 is attached, a board holder holding member 453 that holds the board holder 452, and a biasing member (spring) 454 that biases the board holder 452. When the process cartridge B is attached to the printer main body A, the light unit 450 is situated near the light input portion 501a and the light output portion 501f of the light guide 501 of the process cartridge B, above the photosensitive drum 11.

As illustrated in FIGS. 18A and 18B, the LED 451a serving as the light-emitting portion (light-emitting element) that emits the sensing light, and the phototransistor 451b serving as the light-receiving portion (light-receiving element) and also as the sensing portion that receives and senses the sensing light, are mounted on the remaining amount sensing board 451. A remaining toner amount sensor 500 serving as sensing means of the developer amount in the Present Embodiment is made up of the light guide 501, the LED 451a, and the phototransistor 451b.

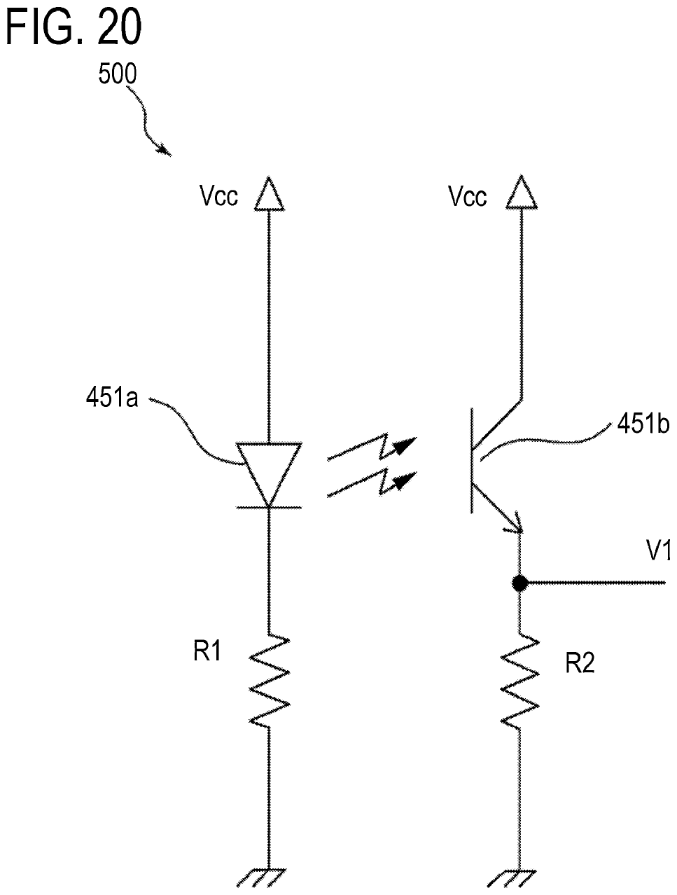

FIG. 20 is a circuit diagram schematically illustrating an example of a circuit configuration of the remaining toner amount sensor 500 according to the Present Embodiment. As illustrated in the circuit diagram of the remaining toner amount sensor 500 in FIG. 20, a switch that is omitted from illustration is provided between the LED 451a and a power source voltage Vcc. Turning this switch to an on state applies voltage from the power source voltage Vcc to the LED 451a, and the LED 451a is in a conducting state. Meanwhile, a switch that is omitted from illustration is also provided between the phototransistor 451b and the power source voltage Vcc, and turning this switch to an on state places the phototransistor 451b in a conducting state, under a current corresponding to the level of light that is sensed.

The power source voltage Vcc and a current restricting resistor R1 are connected to the LED 451a, and the LED 451a emits light under a current that is determined by current restricting resistance. Light emitted from the LED 451a passes through the passage portion 501h inside the toner accommodating chamber 152, and is received by the phototransistor 451b. The power source voltage Vcc is connected to a collector terminal of the phototransistor 451b, and a detecting resistor R2 is connected to an emitter terminal thereof. The phototransistor 451b receives light emitted from the LED 451a, and emits a signal (current) corresponding to the level of light received. This signal is converted into voltage V1 by the detecting resistor R2 as a detection signal, and is input to an analog-to-digital conversion unit (omitted from illustration) of a control unit (omitted from illustration) of the printer main body A. That is to say, the phototransistor 451b varies the value of the output signal (voltage value) in accordance with the amount of toner (developer) accommodated in the toner accommodating chamber 152.

The control unit (central processing unit (CPU)) of the printer main body A determines whether or not the phototransistor 451b has received light from the LED 451a on the basis of the voltage value that is input. The control unit of the printer main body A calculates the toner amount (developer amount) within the toner accommodating chamber 152 on the basis of duration of time of the phototransistor 451b sensing each light, and the intensity of light (level of light) received, when the toner in the toner accommodating chamber 152 is stirred for a predetermined amount of time by the stirring member 154. For example, a table from which remaining toner amount can be output from the time of reception and intensity of light when stirring and conveying the toner by the stirring member 154 is stored in advance in read-only memory (ROM) that the control unit of the printer main body A is provided with. The control unit of the printer main body A can predict/calculate the remaining toner amount on the basis of input to the analog-to-digital conversion unit and the table.

FIGS. 18A and 18B illustrate the state of the light unit 450 and the light guide cover 502 as viewed from a direction perpendicular to a plane on which the LED 451a and the phototransistor 451b of the remaining amount sensing board 451 are provided. In a state in which the process cartridge B is attached to the printer main body A, the sensing light emitted from the LED 451a passes through the optical path in the light guide 501 and the inside of the toner accommodating chamber 152, and arrives at the phototransistor 451b. In a state in which the process cartridge B is not attached to the printer main body A, the LED 451a and the phototransistor 451b of the remaining amount sensing board 451 are covered by the board holder holding member 453.

The board holder 452 is movably held by the board holder holding member 453, and is constantly biased in an arrow H direction by the biasing member 454. In a state in which the process cartridge B is not attached to the printer main body A, the board holder 452 is biased by the biasing member 454 and is situated on an insertion/retraction path of the process cartridge B. Upon the process cartridge B being attached to the printer main body A, the board holder 452 engages the light guide cover 502 of the process cartridge B, and is positioned.

Next, operations of the board holder 452 when attaching the process cartridge B will be described. The board holder 452 has an abutted portion 452a that abuts the light guide cover 502 in the processes of the attaching operation of the process cartridge B, and a positioned portion 452b and a positioned portion 452c for positioning with respect to the process cartridge B. The positioned portion 452b is a face that faces in a direction orthogonal to an insertion/retraction direction of the process cartridge B, and in Embodiment 1 is a flat face that is substantially orthogonal to the insertion/retraction direction. The positioned portion 452c is a face that intersects the positioned portion 452b, and in Embodiment 1 is a flat face that is substantially parallel with the insertion/retraction direction. The abutted portion 452a is a flat face that intersects the positioned portion 452b and the positioned portion 452c, and is an inclined face provided on an end portion on the insertion-direction upstream side of the process cartridge B.

The light guide cover 502 has an abutting portion 502a that abuts the abutted portion 452a, a positioning portion 502b that abuts the positioned portion 452b, and a positioning portion 502c that abuts the positioned portion 452c, in the process of the attaching operations of the process cartridge B. Also, the light guide cover 502 has an input positioning portion 502d that fits the light input portion 501a, and an output positioning portion 502e that is a hole to which is fit the light output portion 501f.

Next, movement of the board holder 452 at the time of attaching operations of the process cartridge B to the printer main body A will be described. As described above, in a state in which the process cartridge B is not attached to the printer main body A, the board holder 452 that is biased in the arrow H direction is situated at a first position on the insertion/extraction path of the process cartridge B. In a state in which the board holder 452 is at the first position, the LED 451a and the phototransistor 451b of the remaining amount sensing board 451 attached to the board holder 452 are covered by the board holder holding member 453.

Upon the process cartridge B being inserted into the printer main body A, first, the abutting portion 502a of the light guide cover 502 abuts the abutted portion 452a of the board holder 452. Thus, the board holder 452 is subjected to force from the light guide cover 502, and moves against the biasing force of the biasing member 454.

Upon the process cartridge B being inserted deeper, the positioning portion 502c abuts the positioned portion 452c. When the process cartridge B is inserted even deeper with the positioning portion 502c and the positioned portion 452c sliding over each other, the positioning portion 502b abuts the positioned portion 452b. Upon attaching of the process cartridge B being completed, the board holder 452 is positioned by the light guide cover 502. Thus, in the process of the process cartridge B being attached to the printer main body A, the board holder 452 is biased by the light guide cover 502 and moves from the first position to a second position. In a state in which the board holder 452 is at the second position, the board holder 452 is pressed by the biasing member 454 in a direction toward the first position. According to such a configuration, in a state in which the process cartridge B is attached to the printer main body A, the positioned portion 452c is subjected to force from the positioning portion 502c in an arrow H1 direction, and the positioned portion 452b is subjected to force from the positioning portion 502b in an arrow H2 direction.

When the process cartridge B is thus attached to the printer main body A and is in a position at which images can be formed, the board holder 452 is situated at the second position, and is pressed against the light guide cover 502 by the biasing member 454. The board holder 452 is positioned as to the light guide cover 502 under reactive force from the light guide cover 502.

In the state in which the board holder 452 is at the second position, the LED 451a and the phototransistor 451b of the remaining amount sensing board 451 attached to the board holder 452 are exposed. The phototransistor 451b is further positioned in accordance with the light input portion 501a by the input positioning portion 502d of the light guide cover 502. In the same way, the LED 451a is positioned in accordance with the light output portion 501f by the output positioning portion 502e. According to such a configuration, the board holder 452 can be position with high precision with respect to the light guide cover 502 and the light guide 501, and remaining toner amount sensing precision can be raised.

According to the configuration described above, the light guide cover 502 has a function of covering such that sensing light does not expose the photosensitive drum 11, and a function of positioning the board holder 452, with respect to the light input portion 501a and the light output portion 501f. Further, according to the configuration of Embodiment 1, the concern of the photosensitive drum 11 being exposed by sensing light, leading to deterioration in image quality, can be reduced, and also remaining toner amount can be sensed in a stable manner since the sensing light passes through the inside of the light guide 501 with high precision.

### Description of Light Guide Cover

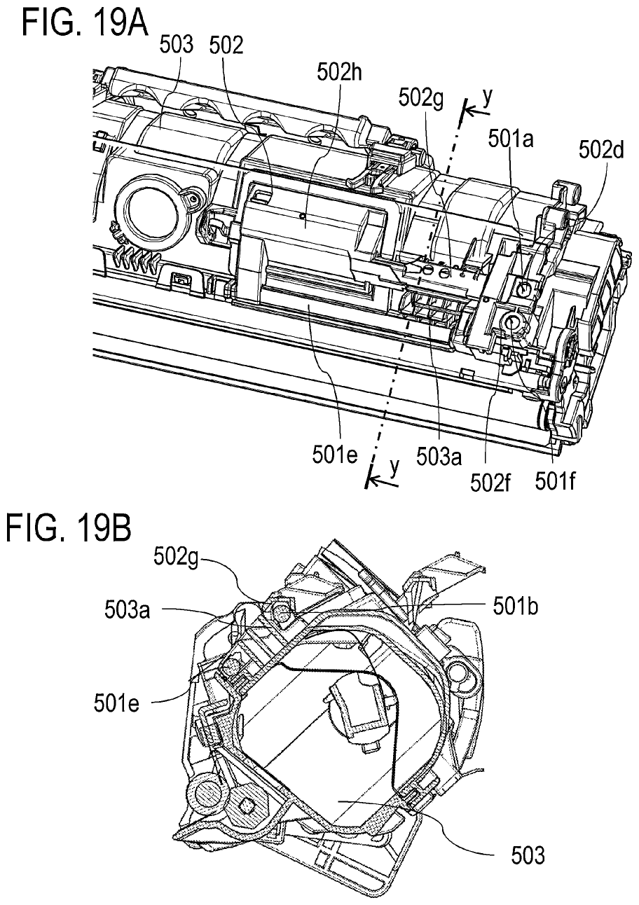

A detailed configuration of the light guide cover 502, which is a feature of the Present Embodiment, will be described with reference to FIGS. 1A, 1B, 19A, and 19B. FIG. 19A is a perspective view of the process cartridge B from a face side on which the light guide cover 502 is provided. FIG. 19B is a cross-sectional view taken along y-y in FIG. 19A, and illustrates a cross-section passing through the light guide cover 502 of the process cartridge B.

As illustrated in FIG. 19A, the light guide cover 502 serving as a cover member is configured to cover each portion of the light guide 501. Specifically, the light guide cover 502 is provided so as to cover the light input portion 501a, the first input straight portion 501b1, the second input straight portion 501b2, the sensing portion 501g, the first output straight portion 501e1, and the light output portion 501f. Conversely, the second output straight portion 501e2 is not covered by the light guide cover 502, and is externally exposed from the developing frame body 503 in a state in which the light guide cover 502 is attached. That is to say, the light guide cover 502 is configured so as not to cover part of the second lightguide portion 5012, and in the Present Embodiment, is configured so as not to cover the second output straight portion 501e2.

The light guide cover 502 has the input positioning portion 502d that covers the perimeter of the light input portion 501a, and the output positioning portion 502e that covers the perimeter of the light output portion 501f. The input positioning portion 502d and the output positioning portion 502e are positioning portions for positioning the light guide cover 502 with respect to the light guide 501. Also, the input positioning portion 502d and the output positioning portion 502e also are protective portions for protecting the light input portion 501a and the light output portion 501f that are most crucial in performing exchange of sensing light in the light guide 501.

The light guide cover 502 is disposed above the photosensitive drum 11. Also, the light guide cover 502 has an input straight cover portion 502g that covers the first input straight portion 501b1, and a sensing portion cover 502h that covers the sensing portion 501g of the light guide 501. According to this configuration, the sensing light can be prevented from exposing the photosensitive drum 11.

Additionally, the developing frame body 503 has an exposure prevention portion 503a that partitions between the first input straight portion 501b1 and the second output straight portion 501e2. The exposure prevention portion 503a and the light guide cover 502 prevent light from entering the first input straight portion 501b1 of the light guide 501, and light from leaking from the first input straight portion 501b1.

Now, the first input straight portion 501b1 and the second output straight portion 501e2 are disposed to the side of the opening portion 504 (laser route R), as illustrated in FIG. 1B. The first input straight portion 501b1 and the second output straight portion 501e2 are disposed arrayed in a direction intersecting the rotation axial line 11b of the photosensitive drum 11, with the first input straight portion 501b1 being situated above the second output straight portion 501e2. In other words, the first input straight portion 501b1 is disposed at a farther position from the photosensitive drum 11 as compared to the second output straight portion 501e2.

Also, the first input straight portion 501b1 is disposed at a farther position from the opening portion 504 (laser route R) as compared to the second output straight portion 501e2. In other words, the light guide 501 is configured such that, in a cross-section orthogonal to the Y direction, a first distance E1 between the first input straight portion 501b1 and the laser route R is greater than a second distance E2 between the second output straight portion 501e2 and the laser route R.

As described above, sensing light emitted by the LED 451a provided to the printer main body A enters the light guide 501 (first lightguide portion 5011) from the light input portion 501a, passes through the first input straight portion 501b1, and exits into the toner accommodating chamber 152. The sensing light that has passed through the toner accommodating chamber 152 then enters the light guide 501 (second lightguide portion 5012) again, passes through the second output straight portion 501e2, and exits from the light output portion 501f toward the phototransistor 451b of the printer main body A. Accordingly, the level of the sensing light is lower at the first output straight portion 501e1, the second output straight portion 501e2, and the light output portion 501f, as compared to the light input portion 501a, the first input straight portion 501b1, and the second input straight portion 501b2. Accordingly, even if the sensing light leaks out from the second output straight portion 501e2 to the outside of the light guide 501, for example, the likelihood that this leaked light will reach the photosensitive drum 11 is low, and effects on the photosensitive drum 11 are small. Meanwhile, the first input straight portion 501b1, the second input straight portion 501b2, and the sensing portion 501g, through which sensing light in a state of having a higher level as compared to the second output straight portion 501e2 passes, are covered by the light guide cover 502. Further, as illustrated in FIG. 19B, the exposure prevention portion 503a provided to the developing frame body 503 covers the first input straight portion 501b1 along with the input straight cover portion 502g. According to this configuration, portions of the light guide 501 through which sensing light in a state with a high level passes are covered by the light guide cover 502 that prevents light from externally leaking, and a partial location through which sensing light in a state with a high level passes is exposed. That is to say, according to the configuration of Embodiment 1, regions that are particularly effective in reducing effects on the photosensitive drum 11 are covered by the light guide cover 502, and the region over which the light guide cover 502 covers the light guide 501 can be suppressed from being excessively broad.

For example, in a case in which the positions of laying out the light input portion 501a and the light output portion 501f are reversed, the first input straight portion 501b1 will be disposed at a position closer to the opening portion 504 and the photosensitive drum 11, as compared to the second output straight portion 501e2. In order to avoid exposing the photosensitive drum 11 with light leaking from the light guide 501, the first input straight portion 501b1 is preferably covered with the light guide cover 502 (input straight cover portion 502g), as described above. However, in a case of providing the input straight cover portion 502g to cover the first input straight portion 501b1 that is in close proximity with the opening portion 504, there is concern that the light guide cover 502 will enter the opening portion 504, and the laser will interfere with the light guide cover 502 and lead to deterioration in image quality. Also, in a case of providing the input straight cover portion 502g such that there is no interference with the laser, there is a need to make the distance between the first input straight portion 501b1 and the laser route R to be great. This leads to necessity of increasing the size of the process cartridge B, reducing the capacity of the toner accommodating chamber 152, or the like.

Conversely, in Embodiment 1, the light input portion 501a and the first input straight portion 501b1 of the light guide 501 are disposed at a position farther from the opening portion 504 and the photosensitive drum 11, as compared to the light output portion 501f and the second output straight portion 501e2. The light guide cover 502 does not cover the second output straight portion 501e2 disposed at a position near to the opening portion 504, and is configured to cover the first input straight portion 501b1, the light input portion 501a, and the light output portion 501f. According to such a configuration, interference with the laser can be prevented while preventing exposure of the photosensitive drum 11 by sensing light, by the light guide cover 502. Additionally, there is no need to provide a cover portion to cover the second output straight portion 501e2, and accordingly costs can be reduced, and also decrease in size of the capacity of the toner accommodating chamber 152 and increase in size of the process cartridge B can be suppressed.

As described above, according to the Present Embodiment, a cartridge and an image forming apparatus can be provided that includes a developing unit that is small in size and can have a large capacity, and that can also perform remaining amount detection that is stable, with a configuration that is small in size and has a high degree of freedom in layout.

### OTHER EMBODIMENTS

Note that the above-described configurations of the image forming apparatus P, process cartridge B, and so forth, are only an example of application of the present invention, and the present invention is not limited to just the embodiment described above. Also, the configurations of the embodiment described above are not necessarily all indispensable to application of the present invention.

For example, although the process cartridge B and the toner cartridge C are described as being separate and each being attached to the printer main body A in Embodiment 1, the process cartridge B and the toner cartridge C may be configured as an integrated cartridge. Also, the components making up the process cartridge B may be provided so as to be non-detachable from the printer main body A.

Also, although the light guide 501 is described as being made up of a single member in Embodiment 1, the light guide 501 may be made up of a plurality of members. For example, the light guide 501 may be configured of a light-transmitting portion such that from the light input portion 501a to the in-accommodation chamber light-exiting face 501c is made up of one member, and from the in-accommodation-chamber light-receiving face 501d to the light output portion 501f is made up of another member.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-107185, filed on Jun. 29, 2023, which is hereby incorporated by reference herein in its entirety.

What is claimed is:

1. An image forming apparatus, comprising:
a photosensitive drum;
an exposing portion that exposes the photosensitive drum;
a developing portion that includes
a frame body that has a toner accommodating portion,
a developing roller that develops an electrostatic image, formed on the photosensitive drum by laser light from the exposing portion, by toner accommodated in the toner accommodating portion, and
a light-transmitting portion attached to the frame body; and
a sensing portion that includes
a light-emitting portion, and
a light-receiving portion that receives light that is emitted from the light-emitting portion, and that passes through inside of the toner accommodating portion via the light-transmitting portion and exits to outside of the toner accommodating portion, the sensing portion emitting a sensing signal in accordance with a level of light received at the light-receiving portion,
wherein the light-transmitting portion includes
a first lightguide portion that guides the light emitted from the light-emitting portion to the inside of the toner accommodating portion, and
a second lightguide portion that guides the light that has passed through the inside of the toner accommodating portion to the light-receiving portion,
wherein the image forming apparatus has a cover member that covers the first lightguide portion and the second lightguide portion,
wherein a part of the second lightguide portion that is closest to a passage region where the laser light passes is at a position closer to the passage region than any of parts of the first lightguide portion, and
wherein the cover member is configured so as not to cover the part that is closest.

2. The image forming apparatus according to claim 1,
wherein the part that is closest is a part extending along a scanning direction of the laser light.

3. The image forming apparatus according to claim 1,
wherein the part that is closest is a part extending along a rotation axial line of the developing roller.

4. The image forming apparatus according to claim 1,
wherein the first lightguide portion includes
a first incident portion to which the light emitted by the light-emitting portion enters, and
a first exiting portion from which the light, entering from the first incident portion, exits toward the inside of the toner accommodating portion,
wherein the second lightguide portion includes
a second incident portion to which the light passing through the inside of the toner accommodating portion enters, and
a second exiting portion from which the light, entering from the second incident portion, exits toward the light-receiving portion, and
wherein the first incident portion and the second exiting portion are each provided on a first end portion of the frame body in a direction of a rotation axial line of the developing roller.

5. The image forming apparatus according to claim 4,
wherein the first exiting portion and the second incident portion are disposed such that, between the first end portion of the frame body and a second end portion opposite from the first end portion in the direction of the rotation axial line, the first exiting portion is at a position closer to the first end portion than the second incident portion, and such as to be arrayed along the rotation axial line, and
wherein the toner accommodating portion has a sensed region which is between the first exiting portion and the second incident portion in the direction along the rotation axial line, and through which the light passes.

6. The image forming apparatus according to claim 5,
wherein the first lightguide portion includes a first straight advance portion that extends along the rotation axial line,
wherein the second lightguide portion includes a second straight advance portion that extends along the rotation axial line, and
wherein the first straight advance portion and the second straight advance portion extend arrayed in a direction orthogonal to the rotation axial line.

7. The image forming apparatus according to claim 6,
wherein the part that is closest is the second straight advance portion.

8. The image forming apparatus according to claim 7,
wherein the second straight advance portion is longer than the first straight advance portion.

9. The image forming apparatus according to claim 7,
wherein the second straight advance portion is closer to the photosensitive drum than the first straight advance portion.

10. A cartridge that is detachable from and attachable to an apparatus main body of an image forming apparatus, the cartridge comprising:
a developing roller;
a frame body that has a toner accommodating portion;
a first lightguide portion that is attached to the frame body and that guides light for sensing an amount of toner accommodated in the toner accommodating portion, from outside of the toner accommodating portion to inside of the toner accommodating portion;
a second lightguide portion that is attached to the frame body and that guides the light that has passed through the inside of the toner accommodating portion to the outside of the toner accommodating portion; and
a cover member covering the first lightguide portion and the second lightguide portion,
wherein a part of the second lightguide portion that is closest to a passage region, where laser light for exposing a photosensitive drum of an exposing portion provided to the apparatus main body passes, is at a position closer to the passage region than any of parts of the first lightguide portion, and
wherein the cover member is configured so as not to cover the part that is closest.

11. The cartridge according to claim 10,
wherein the part that is closest is a part extending along a scanning direction of the laser light.

12. The cartridge according to claim 10,
wherein the part that is closest is a part extending along a rotation axial line of the developing roller.

13. The cartridge according to claim 10,
wherein the first lightguide portion includes
a first incident portion to which the light enters from outside of the frame body, and
a first exiting portion from which the light, entering from the first incident portion, exits toward the inside of the toner accommodating portion,
wherein the second lightguide portion includes
a second incident portion to which the light passing through the inside of the toner accommodating portion enters, and
a second exiting portion from which the light, entering from the second incident portion, exits toward the outside of the toner accommodating portion, and
wherein the first incident portion and the second exiting portion are each provided on a first end portion of the frame body in a direction of a rotation axial line of the developing roller.

14. The cartridge according to claim 13,
wherein the first exiting portion and the second incident portion are disposed such that, between the first end portion of the frame body and a second end portion opposite from the first end portion, the first exiting portion is at a position closer to the first end portion than the second incident portion, and such as to be arrayed along the rotation axial line, and
wherein the toner accommodating portion has a sensed region which is interposed between the first exiting portion and the second incident portion in a direction along the rotation axial line, and through which the light passes.

15. The cartridge according to claim 14,
wherein the first lightguide portion includes a first straight advance portion that extends along the rotation axial line,
wherein the second lightguide portion includes a second straight advance portion that extends along the rotation axial line, and
wherein the first straight advance portion and the second straight advance portion extend arrayed in a direction orthogonal to the rotation axial line.

16. The cartridge according to claim 15,
wherein the part that is closest is the second straight advance portion.

17. The cartridge according to claim 16,
wherein the second straight advance portion is longer than the first straight advance portion.

18. The cartridge according to claim 16,
wherein the second straight advance portion is closer to the photosensitive drum than the first straight advance portion.
